(19) United States
(12) Patent Application Publication
(10) Pub. No.: US 2016/0076427 A1
(43) Pub. Date: Mar. 17, 2016

(54) MODULAR THERMAL-INSULATING ASSEMBLY FOR WATERCRAFT ENGINES

(71) Applicant: West Coast Insulation, Inc. d/b/a West Coast Waterjet, Seattle, WA (US)

(72) Inventors: James M. Heckinger, Seattle, WA (US); Chris Heckinger, Seattle, WA (US)

(21) Appl. No.: 14/852,322

(22) Filed: Sep. 11, 2015

Related U.S. Application Data
(60) Provisional application No. 62/049,906, filed on Sep. 12, 2014.

(51) Int. Cl. F01N 13/14; F01N 13/16; F01N 13/18; F02B 37/18

(52) U.S. Cl. CPC F01N 13/14; F02B 37/183; F01N 13/16; F01N 13/1894

(57) ABSTRACT

Various embodiments are directed towards a modular thermal-insulating assembly. The assembly is operative to thermally insulating an exhaust duct of an engine. The engine may be an engine for a watercraft. The assembly includes a lower-base segment and a top-cover segment. The lower-base segment is positioned vertically below the exhaust duct. The top-cover segment includes a top-cover outer wall. The top-cover outer wall includes a first lateral portion, a second lateral portion, and a horizontal portion. The top-cover segment is coupled to a portion of the lower-base segment. A portion of the exhaust duct is vertically intermediate the portion of the lower-base segment and the horizontal portion of the top-cover outer wall. Furthermore, the portion of the exhaust duct is laterally intermediate the first and the second lateral portions of the top-cover outer wall.

### PRIORITY CLAIM

This patent application claims the priority of U.S. Provisional Patent Application Ser. No. 62/049,906, entitled MODULAR THERMAL-INSULATING ASSEMBLY FOR WATERCRAFT, filed on Sep. 12, 2014, the contents of which are hereby incorporated by reference.

### TECHNICAL FIELD OF THE INVENTION

This patent application relates to modular thermal-insulating assemblies for energy conversion systems. More specifically, this application relates to hardcover, weight-bearing modular assemblies that provide thermal insulation for a ship's engine exhaust manifold. The modular nature of the assemblies enable efficient install, maintenance, and de-install activities.

### BACKGROUND OF THE INVENTION

Internal combustion engines generate exhaust and heat, which are expelled through various exhaust ducts and manifolds. The engine exhaust within the exhaust duct heats the exterior surfaces of the duct, as well as the environment that includes the exhaust ducts. Humans may be required to be within the environment that includes the exhaust ducts. For instance, on a watercraft, such as a cruise ship, human-performed maintenance may be required in spaces that house the exhaust ducts. Furthermore, operational requirements may require the temperature in some circumstances to be below a critical temperature. It is for these and other concerns that the following disclosure is provided.

### SUMMARY OF THE INVENTION

Various embodiments are directed towards a modular thermal-insulating assembly. The assembly is operative to thermally insulating an exhaust duct of an engine. The engine may be an engine for a watercraft. The assembly includes a lower-base segment and a top-cover segment. The lower-base segment is positioned vertically below the exhaust duct. The top-cover segment includes a top-cover outer wall. The top-cover outer wall includes a first lateral portion, a second lateral portion, and a horizontal portion. The top-cover segment is coupled to a portion of the lower-base segment. A portion of the exhaust duct is vertically intermediate the portion of the lower-base segment and the horizontal portion of the top-cover outer wall. Furthermore, the portion of the exhaust duct is laterally intermediate the first and the second lateral portions of the top-cover outer wall.

In at least one embodiment, the top-cover segment includes a first longitudinal opening and a second longitudinal opening that opposes the first longitudinal opening. The portion of the exhaust duct is longitudinally intermediate the first and the second longitudinal openings. A first end of the exhaust duct longitudinally extends out the first longitudinal opening of the top-cover segment. A second end of the exhaust duct longitudinally extends out of the second longitudinal opening of the top-cover segment.

In some embodiments, the assembly further includes an end-cap segment. The end-cap segment includes a longitudinal opening and an end-cap outer wall. The end-cap outer wall has a first lateral portion, a second lateral portion, a horizontal portion, and a longitudinal portion that opposes the end-cap longitudinal opening. The end-cap segment is positioned longitudinally adjacent the top-cover segment. The end-cap segment is coupled to another portion of the lower-base segment. The second end of the exhaust duct is vertically intermediate the other portion of the lower-base segment and the horizontal portion of the end-cap outer wall. The second end of the exhaust duct is laterally intermediate the first and the second lateral portions of the end-cap outer wall. The second end of the exhaust duct is also longitudinally intermediate the longitudinal opening of the end-cap segment and the longitudinal portion of the end-cap outer wall.

In various embodiments, the assembly further includes a shiplap that is positioned longitudinally intermediate the top-cover segment and the end-cap segment. A portion of the shiplap overlaps the top-cover outer wall. Another portion of the shiplap overlaps the end-cap outer wall. An interface between the longitudinally adjacent top-cover segment and the end-cap segment is completely covered by the shiplap.

The shiplap may be an outer shiplap. The top-cover outer wall and the end-cap outer wall are intermediate the outer shiplap and the exhaust duct. In other embodiments, the shiplap is an inner shiplap that is intermediate the exhaust duct and the top-cover outer wall and the end-cap outer wall.

In at least one embodiment, the top-cover segment further includes a top-cover outer wall. A volume between the top-cover outer wall and the top-cover inner wall includes a thermally insulating material. The assembly may further include a wastegate segment. The wastegate segment is positioned over a wastegate of the engine and thermally insulates the wastegate.

Various embodiments are directed towards a module that thermally insulates an exhaust duct of an engine for a watercraft. The module includes an inner wall, and outer wall, and insulating material. The inner wall includes a first inner lateral portion, a second inner lateral portion, and an inner upper portion. The outer wall includes a first outer lateral portion, a second outer lateral portion, and an outer upper portion. The first outer lateral portion opposes the first inner later portion. The second outer lateral portion opposes the second inner lateral portion. The outer upper portion opposes the inner upper portion.

In some embodiments, the module is a weight-bearing module. The module can withstand a weight of at least 200 pounds placed upon the outer upper portion without substantially deforming The insulating material may be fiberglass. The inner wall may be constructed from a first sheet of stainless steel. The outer wall may be constructed from a second sheet of stainless steel.

In some embodiments, the module may be a top-cover module or segment. In other embodiments, the module is an end-cap module or segment. An end-cap module may include an end cap. An end cap may include an inner end-cap wall, an outer end-cap wall, and additional insulating material. The outer end-cap wall opposes the inner end-cap wall. The inner and the outer end-cap walls are positioned at a first longitudinal end of the module.

In at least one embodiments, the module also includes a first longitudinal flange and a second longitudinal flange. The first longitudinal flange is positioned on a first longitudinal perimeter of the outer wall. The first longitudinal flange is coupled to a first longitudinal perimeter of the inner wall. The second longitudinal flange is positioned on a second longitudinal perimeter of the outer wall. The second longitudinal flange is coupled to a second longitudinal perimeter of the inner wall. The first and the second longitudinal flanges couple the inner and the outer walls.

The module may further includes a lower-base segment. The lower-base segment is positioned underneath both the inner and the outer walls. The lower-base segment includes a lower-base wall. The lower-base wall opposes both the inner upper portion of the inner wall and the outer upper portion of the outer wall. The outer wall may include a plurality of brackets. The brackets are operative to couple the module to other modules.

The module may include a shiplap. In various embodiments, the shiplap includes a first shiplap lateral portion, a second shiplap lateral portion, and a shiplap upper portion. The first shiplap lateral portion is adjacent to a longitudinal perimeter of the first inner lateral portion of the inner wall. The second shiplap lateral portion is adjacent to a longitudinal perimeter of the second inner lateral portion of the inner wall. The shiplap upper portion is adjacent to a longitudinal perimeter of the inner upper portion of the inner wall.

Various embodiments are directed towards a modular system for thermally insulating an exhaust duct of an engine. The system includes a plurality of top-cover segments, and end-cap segment, and a plurality of lower-base segments. The top-cover segments are aligned along a longitudinal axis. The end-cap segment is positioned adjacent to a distal top-cover segment of the plurality of top-cover segments. The end-cap segment is aligned on the longitudinal axis. Each of the lower-base segments is below one or more of the top-cover segments or the end-cap segment. The exhaust duct is received by each of the top-cover segments and the end-cap segment. The top-cover segments, the end-cap segment, and the lower-base segments house the exhaust duct.

In at least one embodiment, the system further includes a plurality of wastegate segments to house a plurality of wastegates of the engine. The plurality of top-cover segments may include at least five top-cover segments.

### BRIEF DESCRIPTION OF THE DRAWINGS

Preferred and alternative examples of the present invention are described in detail below with reference to the following drawings:

FIG. 1A illustrates exhaust manifolds prior to the installation of a modular insulating assembly that is consistent with the various embodiments disclosed herein.

FIG. 1B shows a view of an insulating assembly in mid-installation around exhaust ducts that is consistent with the various embodiments disclosed herein.

FIG. 2A illustrates another view of a mid installation of the assembly that is consistent with the various embodiments disclosed herein.

FIG. 2B illustrates a completed installation of a modular insulating assembly that is installed over and insulating the exhaust ducts of a ship's engine that is consistent with the various embodiments disclosed herein.

FIG. 3A illustrates the installation of an end-cap segment of an insulating modular assembly that is consistent with the various embodiments disclosed herein.

FIG. 3B shows a side-view of an end-cap segment sitting on top of a lower-base segment that is consistent with the various embodiments disclosed herein.

FIG. 4A shows the wastegates wrapped in an insulating pad prior to a wastegate segment of a modular insulating assembly is installed.

FIG. 4B shows wastegate segments of an insulating assembly installed over and insulating the wastegates of FIG. 4A.

FIG. 5A illustrates multiple views of an embodiment of a modular insulating assembly for a V-12 engine with short V-12.

FIG. 5B illustrates multiple views of an embodiment of a modular insulating assembly for a V-12 engine with long V-12 wastegates.

FIG. 5C illustrates multiple views of an embodiment of a modular insulating assembly for a V-16 engine with V-16 wastegates.

FIG. 6A shows various views of the construction of an outer sheet of a top-cover segment that is consistent with the various embodiments disclosed herein.

FIG. 6B shows various views of the construction of an inner sheet of a top-cover segment that is consistent with the various embodiments disclosed herein.

FIG. 6C shows an exploded view of a top-cover segment that is consistent with the various embodiments disclosed herein.

FIG. 6D shows various views of the top-cover segment of FIG. 6C.

FIG. 7A illustrates various views of an inner shiplap that is consistent with the various embodiments disclosed herein.

FIG. 7B illustrates an exploded view of a top-cover segment that includes two inner shiplaps, one on each longitudinal end of the top-cover segment that is consistent with the various embodiments.

FIG. 7C shows various views of the completed top-cover segment that includes inner shiplaps on both longitudinal ends of the top-cover segment.

FIG. 8A illustrates various views of an outer sheet for an end-cap segment that is consistent with the various embodiments disclosed herein.

FIG. 8B illustrates various views of an inner sheet for an end-cap segment that is consistent with the various embodiments disclosed herein.

FIG. 8C shows various views of an outer end-cap wall of an end-cap segment that is consistent with the various embodiments disclosed herein.

FIG. 8D shows various views of an inner end-cap wall of an end-cap segment that is consistent with the various embodiments disclosed herein.

FIG. 8E illustrates an exploded view of an end-cap segment that is consistent with the various embodiments disclosed herein.

FIG. 8F shows various views of the completed end-cap segment of FIG. 8E.

FIG. 9A shows various views of an outer shiplap that is employed to overlap adjacent top-cover and/or end-cap segments.

FIG. 9B shows a bracket that is included in various top-cover segments, end-cover segments, and lower-base segments as disclosed herein.

FIG. 9C shows an embodiment of a handle that is welded onto various embodiments of top-cover segments, end-cap segments, and lower-base segments disclosed herein.

FIG. 10A shows an exploded view of a lower-base segment that is consistent with the various embodiments disclosed herein.

FIG. 10B shows various views of an assembled lower-base segment that is consistent with the embodiments disclosed herein.

FIG. 11A shows various views of a V-12 wastegate segment for a V-12 engine configuration.

FIG. 11B shows various views of a V-16 wastegate segment for a V-12 engine.

FIG. 11C shows various views of a V-16 wastegate segment for a V-16 engine configuration.

FIG. 12A shows an exploded view for a turbo end-cover segment for a V-12 engine configuration.

FIG. 12 B shows an exploded view for a turbo upper fitment for a V-16 engine configuration.

### DETAILED DESCRIPTION OF THE PREFERRED EMBODIMENT

To facilitate the understanding of this invention, a number of terms are defined below. Terms defined herein have meanings as commonly understood by a person of ordinary skill in the areas relevant to the present invention. Terms such as “a,” “an,” and “the” are not intended to refer to only a singular entity, but include the general class of which a specific example may be used for illustration. The terminology herein is used to describe specific embodiments of the invention, but their usage does not delimit the invention, except as outlined in the claims.

The present disclosure presents various embodiments of weight bearing modular thermally insulating assemblies for vehicle energy conversion systems. In preferred embodiments, the vehicle is a watercraft. However, the invention is not so constrained, and the vehicle may be any structure that is propelled over land, sea, air, or space. The watercraft may be a vessel or a ship, such as a cruise ship, a shipping liner, a fishing vessel, or the like. However, the invention is not so constrained and the watercraft may be any structure that is propelled through a body of water and includes an energy conversion system.

The modular assemblies are employed to thermally insulate heated structures and/or surfaces included within the vessel. The modular assemblies may be used to meet safety standards and prevent exposure to the heated surfaces that are insulated by and housed within the body of the assembly. In preferred embodiments, the assemblies are installed to enclose at least a portion of the surfaces that are heated due to inefficiencies in one or more energy conversion systems installed on the vessel. Because the assemblies are thermally insulating, volumes outside of the heating assemblies are at least partially protected from the higher temperatures of the structures and/or surfaces housed within the assemblies. In preferred embodiments, the amount of heating outside of the assemblies, due to the higher temperatures within, is decreased enough so that various safety standards and/or safety requirements are satisfied.

In some embodiments, the energy conversion system is an engine, such as a diesel or a gasoline-powered engine. In preferred embodiments, the engine is coupled to an electrical generator to supply the ship with electrical power. However, the invention is not so constrained, and the energy conversion system may be employed in any application where energy conversion is required by the watercraft, such as ship propulsion.

In some embodiments, the engine is a V-12 engine. In other embodiments, the engine is a V-16 engine. However, the invention is not so constrained, and the engine may include any number of piston/cylinder pairs. The engine may be a two-stroke or a four-stroke engine. It is to be understood that the invention may be employed with any engine configuration. In some embodiments, the engine is a turbo-charged engine. In such embodiments, the engine may include various structures associated with turbo-chargers, such as wastegates that enable the decompression of turbo-charged air. The wastegates may be in a V-12, V-16, or any other such configuration.

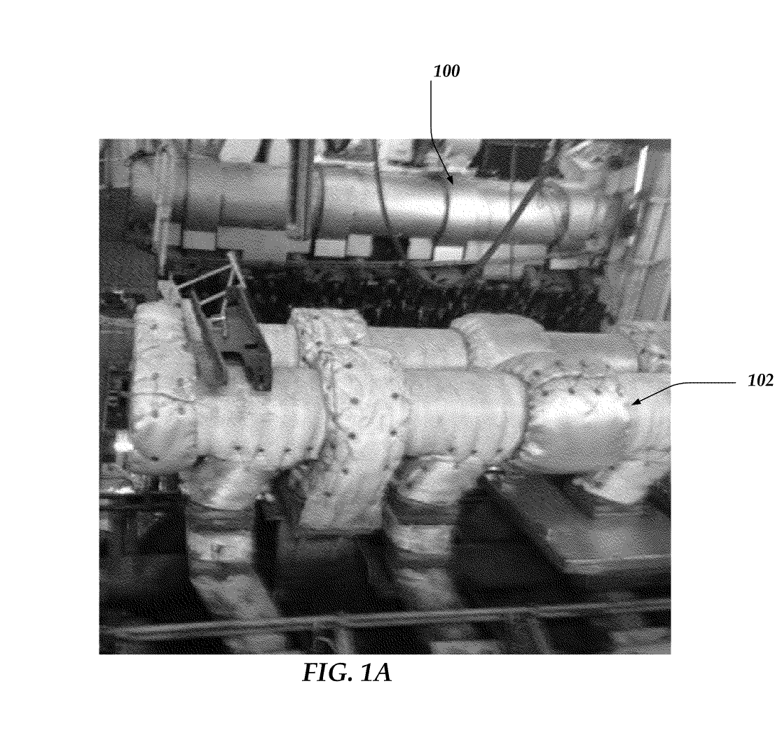

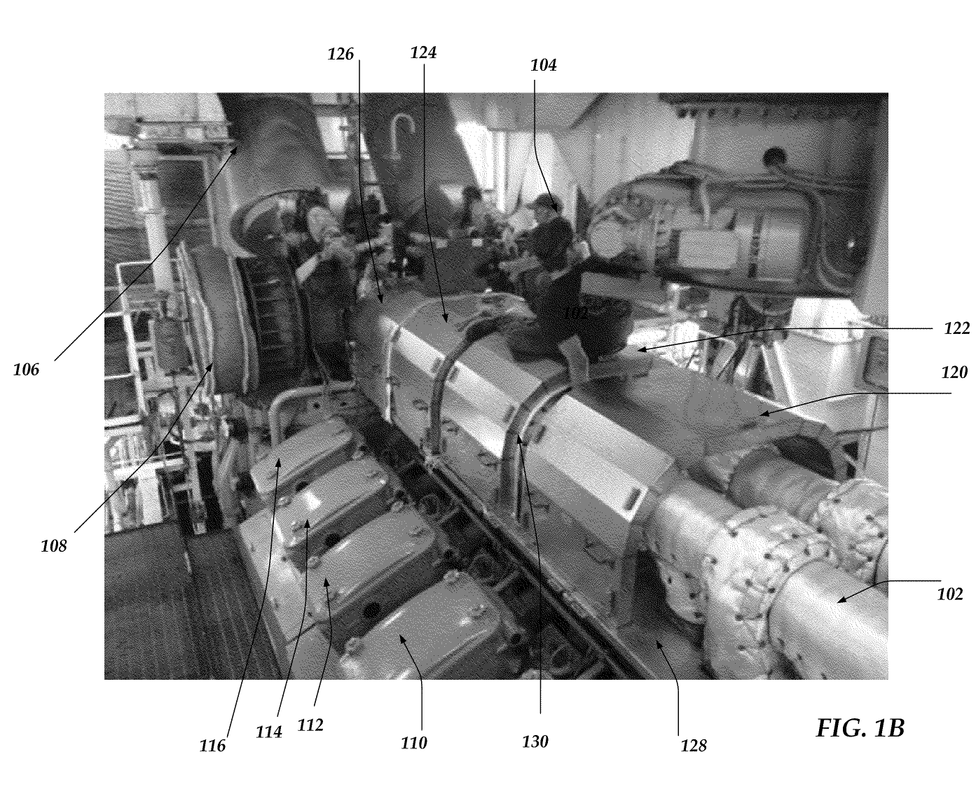

In preferred embodiments, the insulating assemblies are installed to at least partially house and insulate engine exhaust manifolds. FIG. 1A illustrates exhaust manifolds prior to the installation of a modular insulating assembly that is consistent with the various embodiments disclosed herein. The exhaust ducts in the foreground of FIG. 1A have been wrapped with insulating wraps 102 and/or insulating pads. The exhaust ducts in the background 100 have not been wrapped with the insulating pads. The use of insulating pads 102 is optional. In preferred embodiments, the modular assemblies provide adequate insulation for at least a portion of the structures or surfaces to be insulated, such that the use of insulating pads 102 is not required. However, in embodiments where greater insulating capabilities are desired, the surfaces may be encased in insulating wraps 102 or pads prior to the installation of the assemblies. The various components of the modular insulating assemblies are sized to accommodate the insulating pads 102 if used.

FIG. 1B shows a view of an insulating assembly in mid-installation around exhaust duct that is consistent with the various embodiments disclosed herein. The exhaust ducts that are wrapped with insulating pads 102 are not yet completely housed within the insulating assembly because the installation of the assembly is not yet complete. The human installer 104 is shown in FIG. 1B provide a scale for the linear dimensions of various assembly components. Note that the assembly is a weight bearing structure, as a human installer 104 is shown sitting on the partially installed insulating assembly. The ducts are wrapped in the insulating pads 102. The upper portion of four of the engine's cylinder blocks 110, 112, 114, 116 are shown in FIG. 1B. Portions of the turbo-charger 108 and wastegates 106 are also shown.

FIG. 1B shows four top-cover segments sitting atop lower-base segments 120, 122, 124, 126. Note that each of the top-cover segments 120-126 is pairs with one of the engine cylinder blocks 110-116. For instance, the top-cover segment 120 covers the portion of the duct that is adjacent to the cylinder block 110. The adjacent top-cover segments 120-126 are not yet coupled to each other or the corresponding lower-base segment 128. An inner shiplap 130 is coupled to the inner surface of the top-cover segment 122. The outer shiplaps are not yet positioned to thermally seal the seams of adjacent top-cover segments 120-126.

When the installation of the modular assembly is complete, the various embodiments thermally insulate the exhaust manifolds and ducts such that the exposure of volumes outside of the assemblies to the elevated temperatures within the assemblies is substantially decreased. Furthermore, the temperatures of the outer surfaces of the assemblies remain at a temperature that is within an acceptable range for safety considerations. In preferred embodiments, when the engine is working at maximum power and/or torque output, all of the outer surfaces of the assemblies are at a temperature that is less than the combustion temperature of diesel fuel. In some embodiments, the assemblies additionally thermally insulate portions of an engine turbo-charger 108 and corresponding wastegates 106.

An assembly includes various modular components and/or segments, such as top-cover segments, end-cap segments, lower-base segments, inner and outer shiplaps, wastegate segments, turbo fitments, spray-skirt segments, mounting rails, mounting brackets, and the like. As discussed further below, the shiplaps are used to couple adjacent segments, such as adjacent top-cover segments 120 and 122 of FIG. 1B, and/or end-cap segments. In preferred embodiments, at least some of the components are constructed from a thermally reflective material such as stainless steel. However, other thermally reflective or thermally insulating materials may be used in the construction of at least some of the various components.

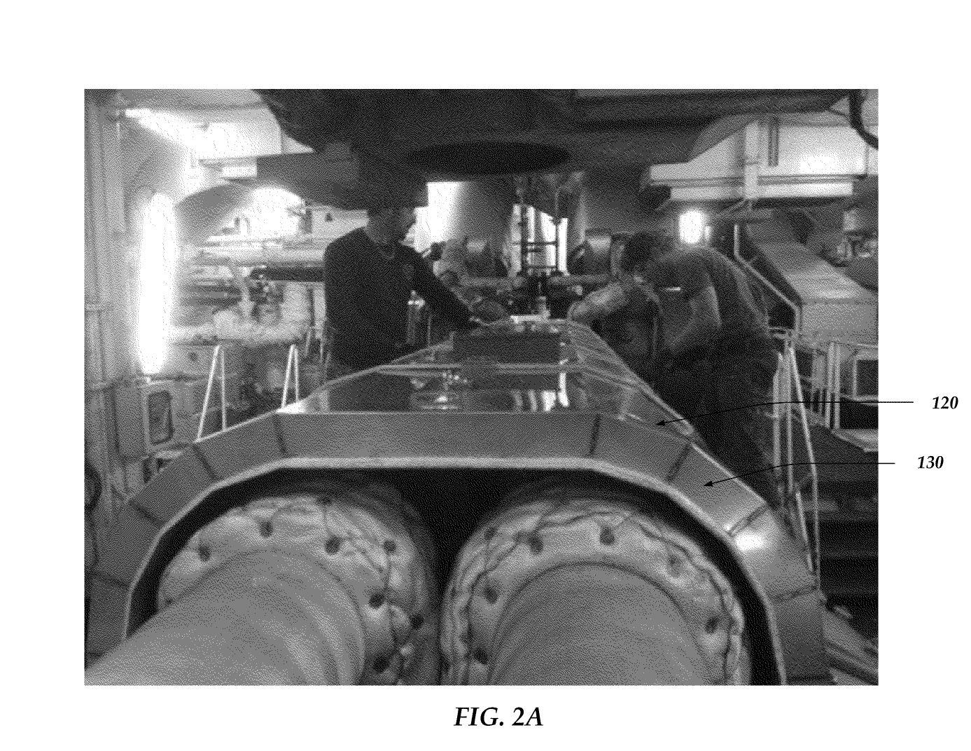

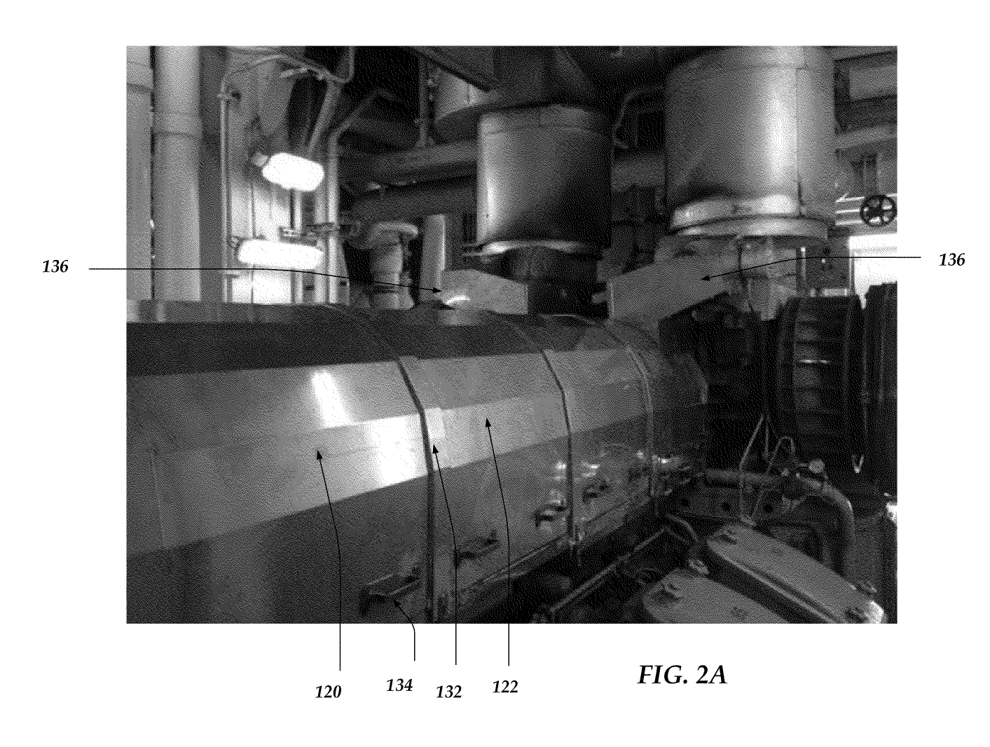

FIG. 2A illustrates another view of a mid installation of the assembly that is consistent with the various embodiments disclosed herein. FIG. 2A shows an interface between individual top cover segments. The sidewall 130 of top-cover segment 120 is shown in FIG. 2A. As discussed, the seams or interfaces between top cover segments are thermally sealed with an inner and an outer shiplap member or sealing strap. An insulating tape, strip, or film may be disposed intermediate at least some of the adjacent surfaces, such as the sidewalls of the shiplaps, top-cover segments, end-cap segments, and other adjacent surfaces. The construction of the individual top cover segments and inner and outer shiplap segments is discussed below.

FIG. 2B illustrates a completed installation of a modular insulating assembly that is installed over and insulating the exhaust ducts of a ship's engine that is consistent with the various embodiments disclosed herein. FIG. 2B shows the outer shiplap segments coupling top cover segments. For instance, outer shiplap segment 132 couples top-cover segment 120 to top-cover segment 122. Brackets and through-bolts are used to couple adjacent top-cover and/or end-cap segments. As discussed further below, the inner and outer shiplap segments are sandwiched between adjacent top-cover and/or end-cap segments. Furthermore, both the inner and outer shiplap segments overlap each of the adjacent top-cover and end-cap segments to thermally seal the seams between the adjacent segments.

During installation, the individual segments and/or components may be positioned with the use of a crane is the ship's engine bay. s are welded onto the outer surfaces of the various segments to provide a coupling structure the enable positioning with the crane. For instance, handle 134 is welded onto a bottom portion of a side outer surface of top-cover segment 120. Furthermore, installers may maneuver individual top-cover and end-cover segments with the use of the handles. FIG. 2B also illustrates insulating wastegate segments 136 installed around the engine's wastegates.

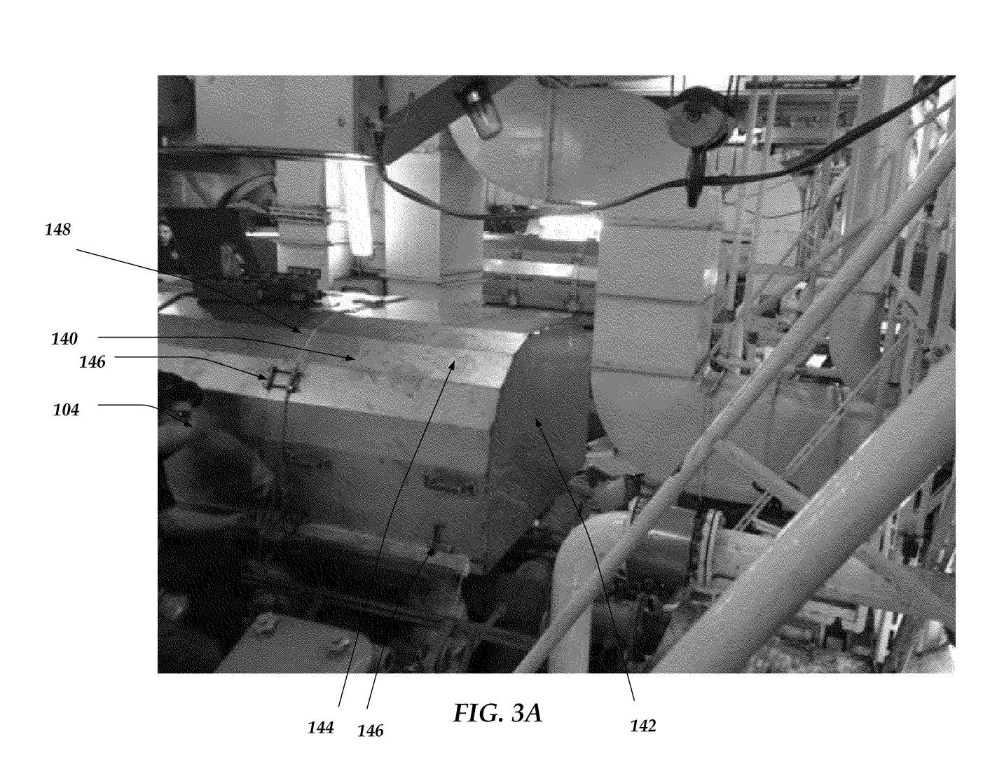

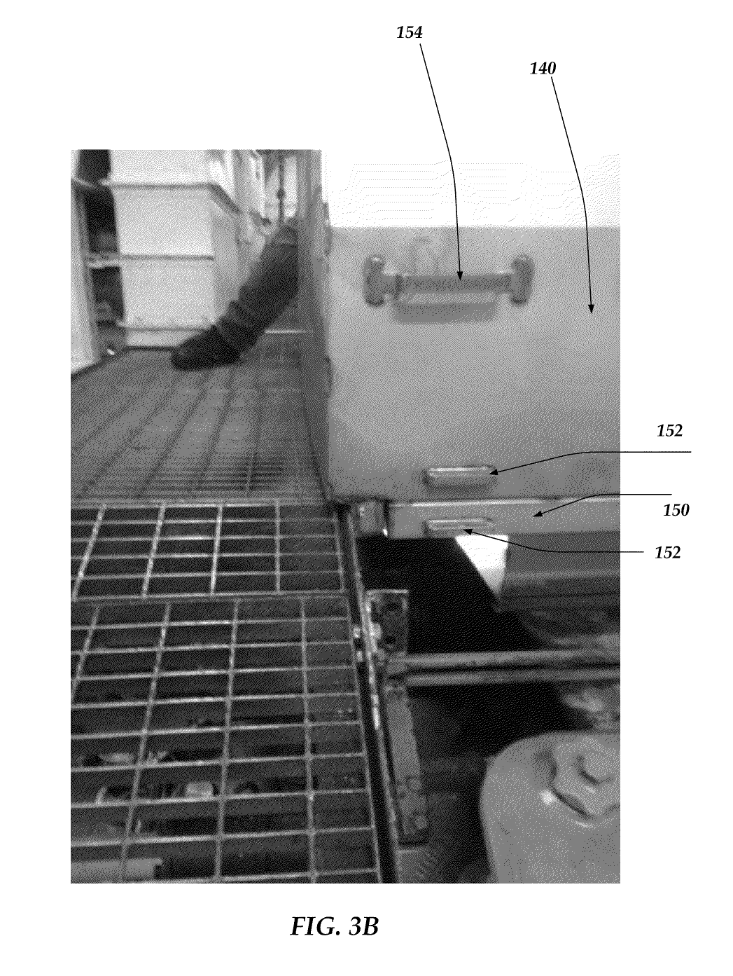

FIG. 3A illustrates the installation of an end-cap segment of an insulating modular assembly that is consistent with the various embodiments disclosed herein. End-cap segments are installed around the most distal ends of the exhaust ducts. For example, end-cap segment 140 is installed at the distal end of the insulating assembly. End-cap segment 140 includes an end-cap end wall 142 on the most distal longitudinal end of end-cap segment 140. The end-cap segment 140, including the end-cap lateral walls 144 and end-cap end wall 142 are thermally insulating walls.

In FIG. 3A, the human installer 104 is installing through-bolts 146 that couple brackets welded onto adjacent top-cover and end-cap segments. Brackets and through-bolts 146 also couple top-cover and end-cap segments to the lower base segments. The outer shiplap 148 is sandwiched between the top-cover segments, end-cap segments, and mounting brackets.

FIG. 3B shows a side-view of an end-cap segment 140 sitting on top of a lower-base segment 150 that is consistent with the various embodiments disclosed herein. Brackets 152 oriented horizontally are shown on the end-cap segment 140 and the lower-base segment 150. A horizontally oriented handle 154 is shown above the brackets 152. An installer will position at least one through-bolt, such as through-bolt 146 of FIG. 3A, oriented vertically, through both brackets 152 to couple the end-cap segment 140 and lower-base segment 150. In preferred embodiments, at least two through-bolts are used for each coupling point.

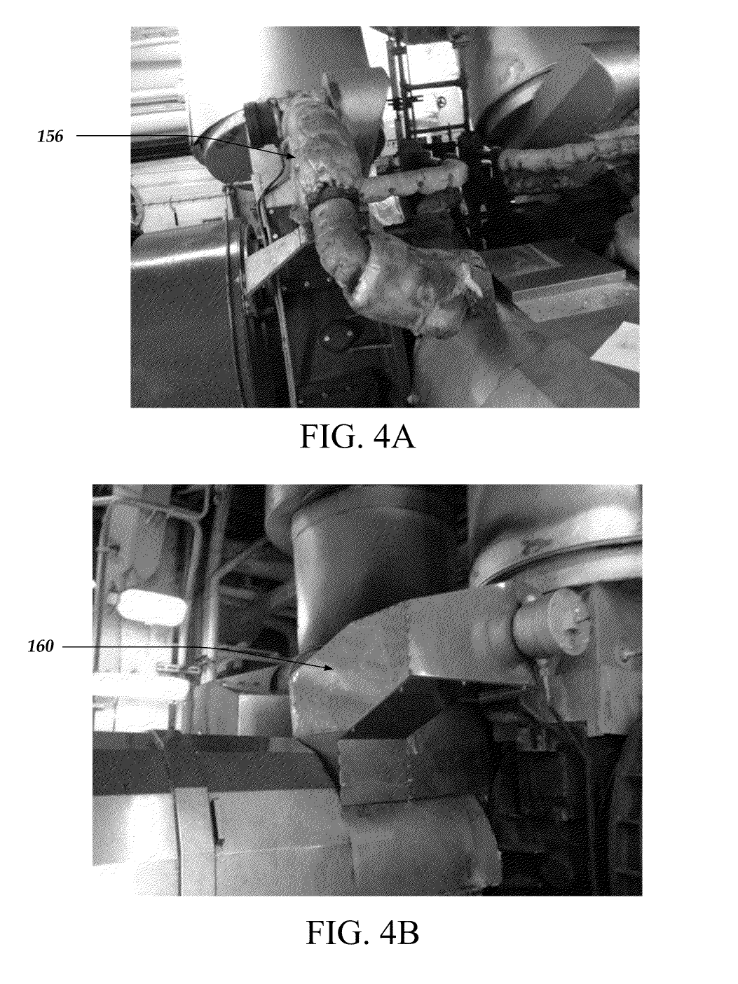

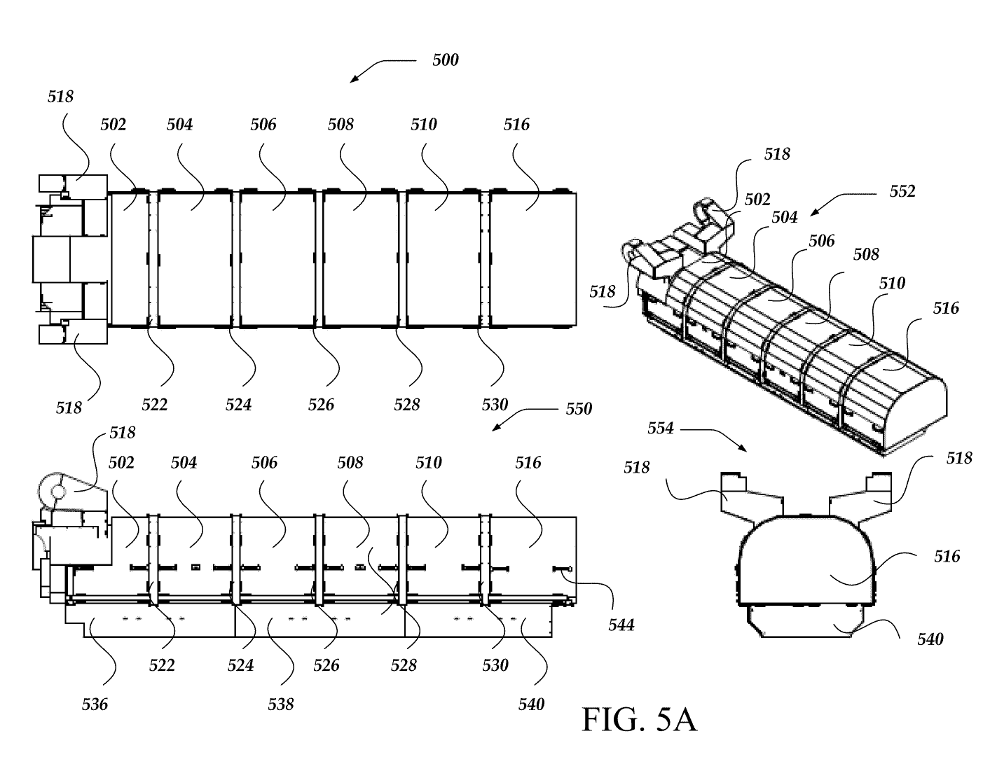

FIG. 4A shows the wastegates 156 wrapped in an insulating pad, such as insulating pad 102 of FIGS. 1A-1B prior to a wastegate segment being installed. FIG. 4B shows wastegate segments 160 of an insulating assembly installed over and insulating the wastegates of FIG. 4A. In some embodiments, even though the exhaust ducts are not wrapped with insulating pads, the wastegate ducts are wrapped with insulating pads.

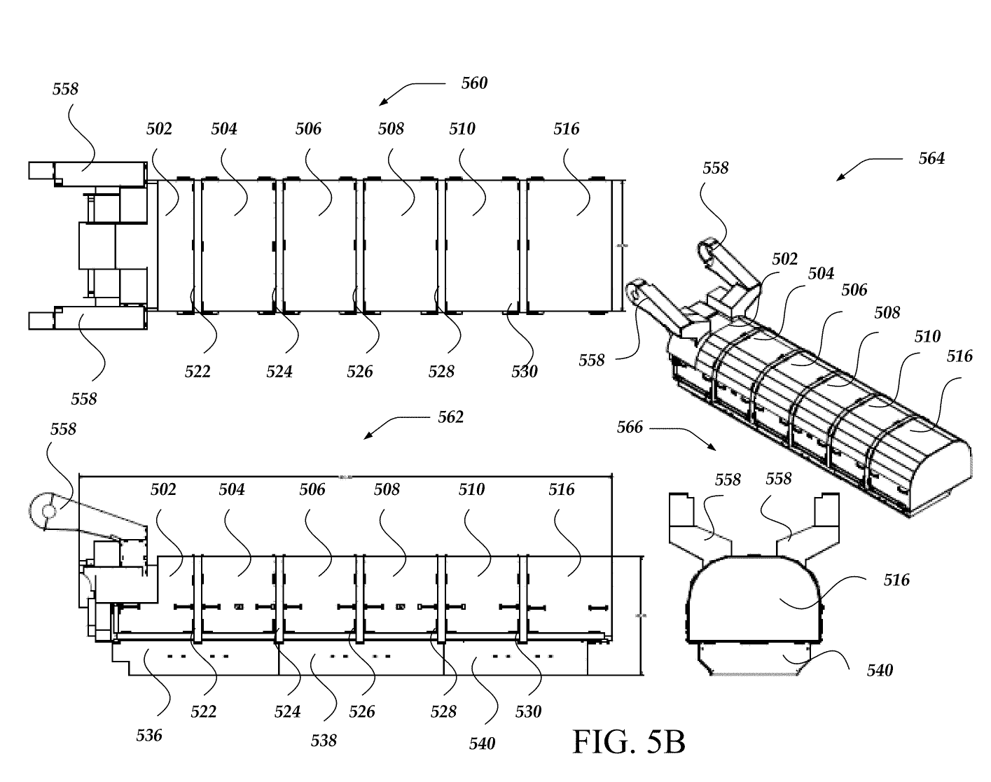

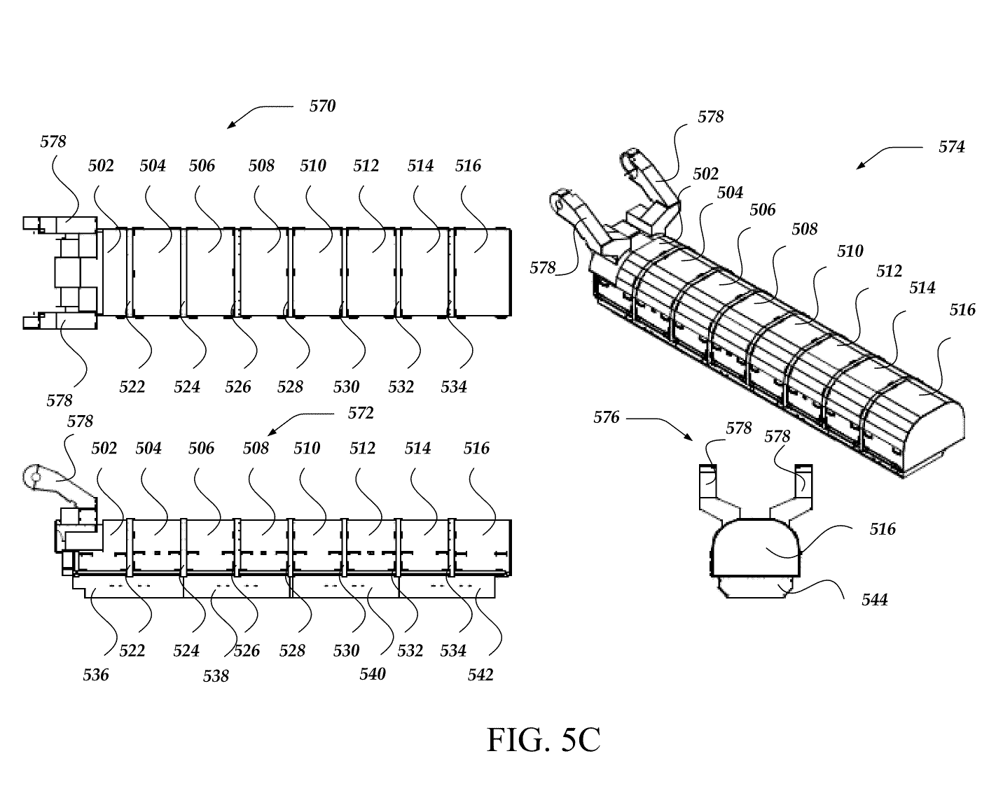

FIG. 5A illustrates multiple views of an embodiment of a modular insulating assembly for a V-12 engine with short V-12 wastegates. View 500 shows a top-view of the insulating assembly. View 550 shows a side-view of the insulating assembly. View 554 shows an end-view of the insulating assembly. View 552 shows an off-axis view of the insulating assembly.

The V-12 insulating assembly includes five top-cover segments 501, 504, 506, 508, and 510, as well as end-cap segment 516 and short V12 wastegate segments 518. The insulating assembly includes five outer shiplaps 522, 524, 526, 528, 530, each positioned intermediate two adjacent top-cover segments or a top-cover segment and an adjacent end-cap segment. The top-cover segments 502-510 and the end-cap segment 516 are coupled to one or more of three lower-base segments 536, 538, 540.

FIG. 5B illustrates multiple views of an embodiment of a modular insulating assembly for a V-12 engine with long V-12 wastegates. The insulating assembly of FIG. 5B is similar to the insulating assembly of FIG. 5A. The long V12 wastegate segments 558 of FIG. 5B are longer than short V12 wastegate segments 518 of FIG. 5A to accommodate the longer wastegates of an engine.

View 560 shows a top-view of the insulating assembly. View 562 shows a side-view of the insulating assembly. View 566 shows an end-view of the insulating assembly. View 564 shows an off-axis view of the insulating assembly.

FIG. 5C illustrates multiple views of an embodiment of a modular insulating assembly for a V-16 engine with V-16 wastegates. View 570 shows a top-view of the insulating assembly. View 572 shows a side-view of the insulating assembly. View 576 shows an end-view of the insulating assembly. View 574 shows an off-axis view of the insulating assembly.

The V-16 insulating assembly includes seven top-cover segments 501, 504, 506, 508, 510, 512, 514 as well as end-cap segment 516 and V16 wastegate segments 578. The insulating assembly includes seven outer shiplaps 522, 524, 526, 528, 530, 532, 534, each positioned intermediate two adjacent top-cover segments or a top-cover segment and an adjacent end-cap segment. The top-cover segments 502-514 and the end-cap segment 516 are coupled to one or more of four lower-base segments 536, 538, 540, 542.

In various embodiments, some of the components, such as top-cover segments, end-cap-segments, and lower-base segments are constructed from at least two layers, walls, or sheets: an inner sheet and an outer sheet. In such embodiments, the segments may be double walled segments. Preferably, a thermally insulating material, such as fiberglass or other shape accommodating material, is sandwiched between the inner and outer stainless steel sheets (or walls) to increase the insulating capabilities of the various components. Other insulating materials that may be sandwiched between the inner and outer walls of the components include, but are not limited to, mineral wool, ceramic materials, or aerogel. Virtually any material that is a thermally insulating material may be sandwiched between the inner and outer walls of at least some of the components. In other embodiments, the space between the double walls may be evacuated of air to enhance the insulating capabilities of the segment.

The characteristics of the insulating material, such as density and overall insulating power may be tailored to the specific application. The insulating material may fill the volume or void between the inner and outer sheets (or the double walls). Sidewalls may be used to couple the inner and outer sheets and provide enhanced insulating capabilities. In at least one embodiment, sidewalls, inner sheets, and outer sheets are coupled to form the component or segment with weld joints.

In some embodiments, at least a portion of the stainless steel for each of the sheets includes a 2B or better finish. In preferred embodiments, both the inner and outer surfaces of the both the inner and outer stainless-steel sheets are finished with a 2B or better finish, At least one of the inner or outer surfaces of the stainless steel may include a heat-reflective finish to provide additional thermal insulating capabilities.

The various components included in the assemblies are modular and/or interchangeable. Accordingly, the efficiency of installing, maintaining, and de-installing the assemblies is increased, at least in part because of the modular and interchangeable nature of the various assembly components. For instance, a team of installers has completed installation of an assembly within a 12-hour shift. Depending on the complexity of the engine configuration, installers may install some embodiments within a single day. This efficiency provides a great enhancement over prior-art systems. Furthermore, because of the modular nature, the amount of tailoring or customization to a particular ship, engine, exhaust manifold, turbo-charger, and/or wastegate configuration is minimized. The various components may be mixed-and-matched to provide the required insulation for various configurations of a specific ship or vessel.

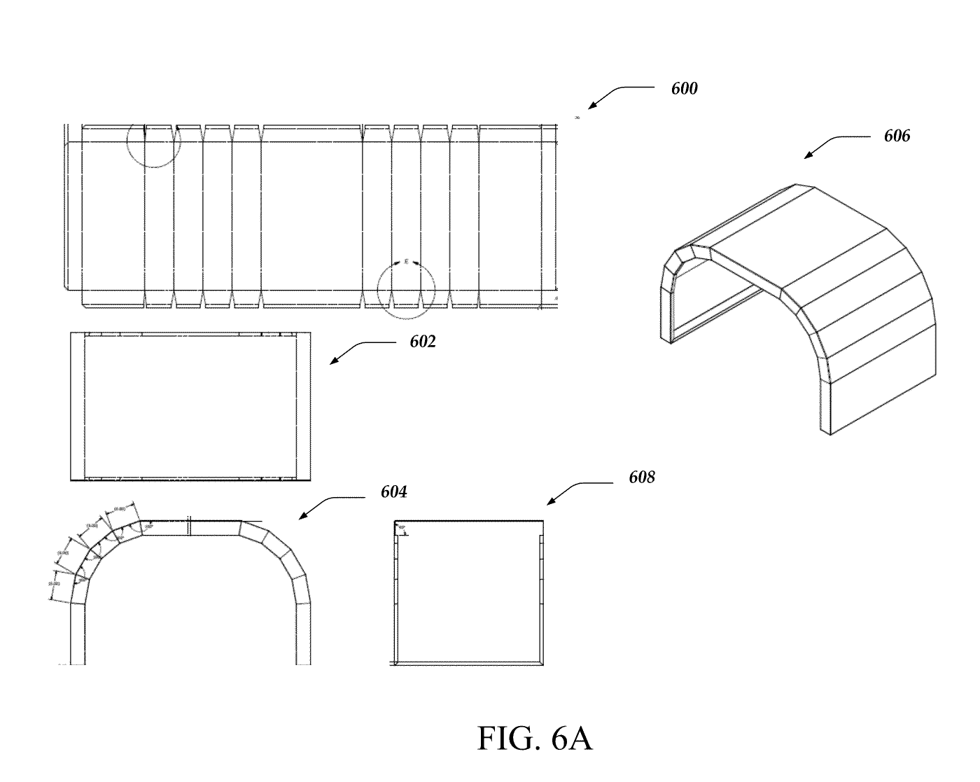

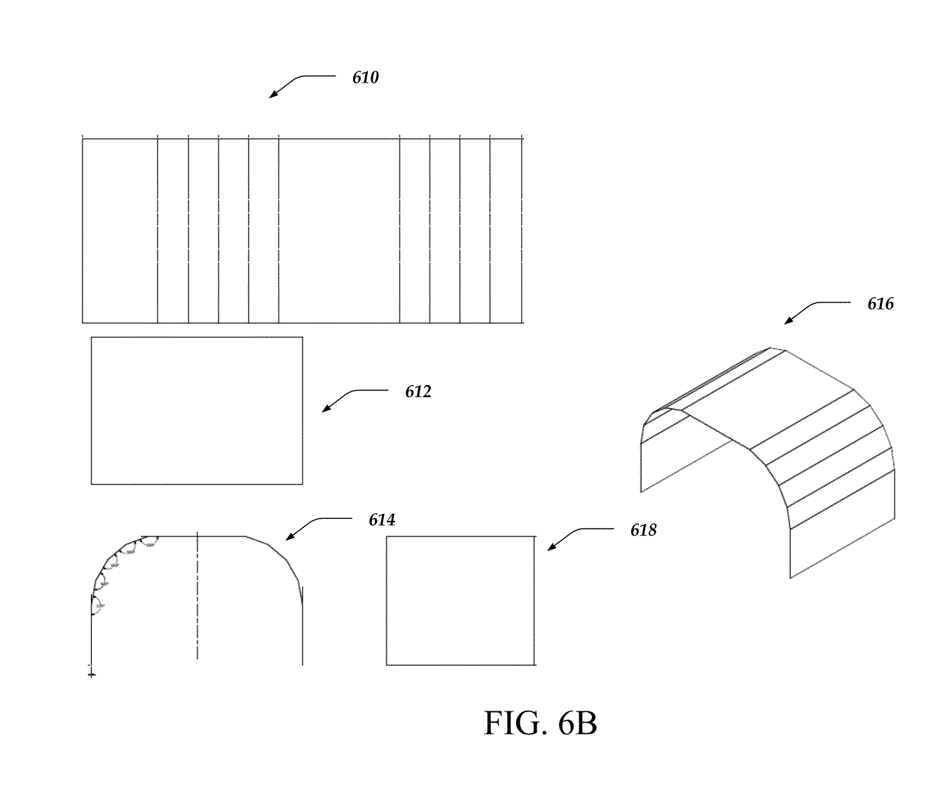

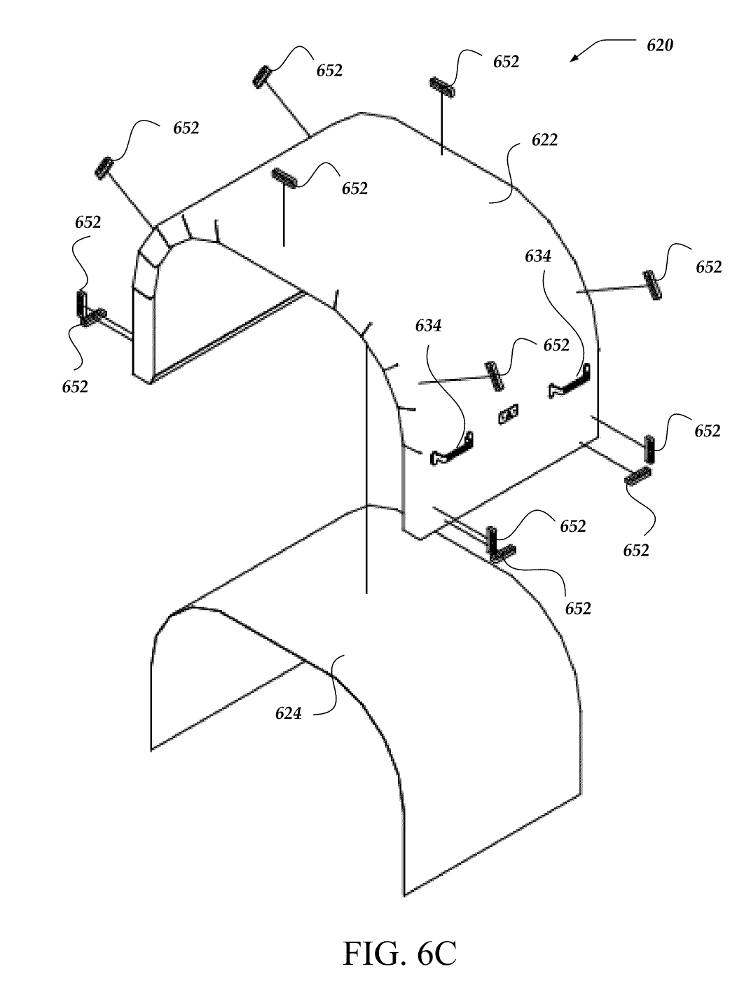

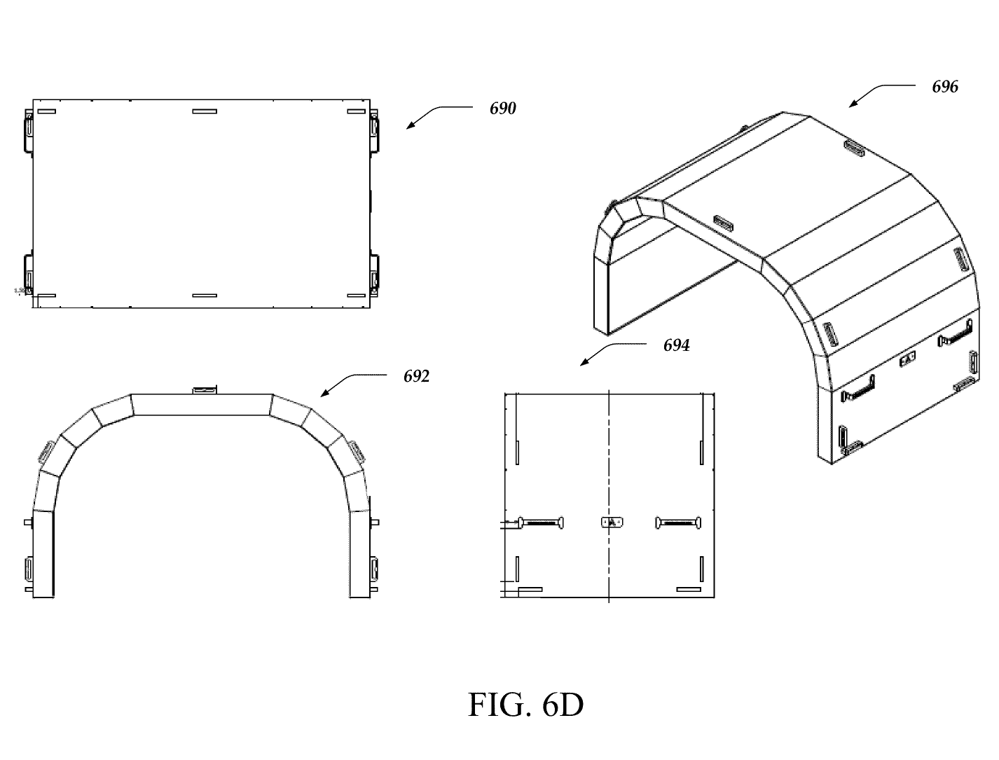

FIG. 6A shows various views of the construction of an outer sheet of a top-cover segment that is consistent with the various embodiments disclosed herein. For instance, the outer sheet of FIG. 6A may include the outer surfaces of any of top-cover segments 502-515 of FIGS. 5A-5C. In various embodiments, the outer sheet of a top-cover segment is constructed from a single sheet of stainless steel that is cut and folded to form the top-cover's outer sheet.

View 600 of FIG. 6A shows a single sheet of stainless steel that has been cut and scored to form an outer sheet of a top-cover segment. View 602 shows a top-view of the outer sheet constructed from sheet of view 600. View 604 shows a front-view of the outer sheet. View 606 shows an off-axis view of the outer sheet. View 608 shows an side-view of the outer sheet. The various folded edges may be coupled with weld joints. The outer sheet includes a portion of the sidewall of the top-cover segment. Linear length, as well as angles, may be varied to construct top-cover segments of varying sizes and shapes. For instance, the dimensions and angles may be scaled to accommodate other heated structures that are to be insulated by the assembly.

FIG. 6B shows various views of the construction of an inner sheet of a top-cover segment that is consistent with the various embodiments disclosed herein. For instance, the inner sheet of FIG. 6B may include the inner surfaces of any of top-cover segments 502-515 of FIGS. 5A-5C. In various embodiments, the inner sheet of a top-cover segment is constructed from a single sheet of stainless steel that is cut and folded to form the top-cover's inner sheet.

View 610 of FIG. 6B shows a single sheet of stainless steel that has been cut and scored to form an inner sheet of a top-cover segment. View 612 shows a top-view of the inner sheet constructed from the sheet of view 610. View 614 shows a front-view of the inner sheet. View 616 shows an off-axis view of the inner sheet. View 618 shows a side-view of the inner sheet. The various folded edges may be coupled with weld joints. The outer sheet includes a portion of the sidewall of the top-cover segment. Linear length, as well as angles, may be varied to construct top-cover segments of varying sizes and shapes. For instance, the dimensions and angles may be scaled to accommodate other heated structures that are to be insulated by the assembly.

FIG. 6C shows an exploded view of a top-cover segment 620 that is consistent with the various embodiments disclosed herein. Top-cover segment 620 includes an outer sheet 622 and an inner sheet 624. Outer sheet 622 may be similar to the outer sheet of FIG. 6A. Inner sheet 624 may be similar to inner sheet of FIG. 6B.

As noted above, in preferred embodiments, an insulating material is positioned between the inner sheet 624 and outer sheet 622 to fill the volume between the inner sheet 624 and outer sheet 622. Multiple weld joints may be used to couple the inner and outer sheets. Top-cover segment 620 also includes a plurality of brackets 652, or latches, and handles 634.

FIG. 6D shows various views of the top-cover segment of FIG. 6C. View 690 of FIG. 6D shows a top-view of top-cover segment 620 of FIG. 6C. View 692 shows a front-view of top-cover segment 620. View 694 shows a side-view of top-cover segment 620. View 696 shows an off-axis view of top-cover segment 620.

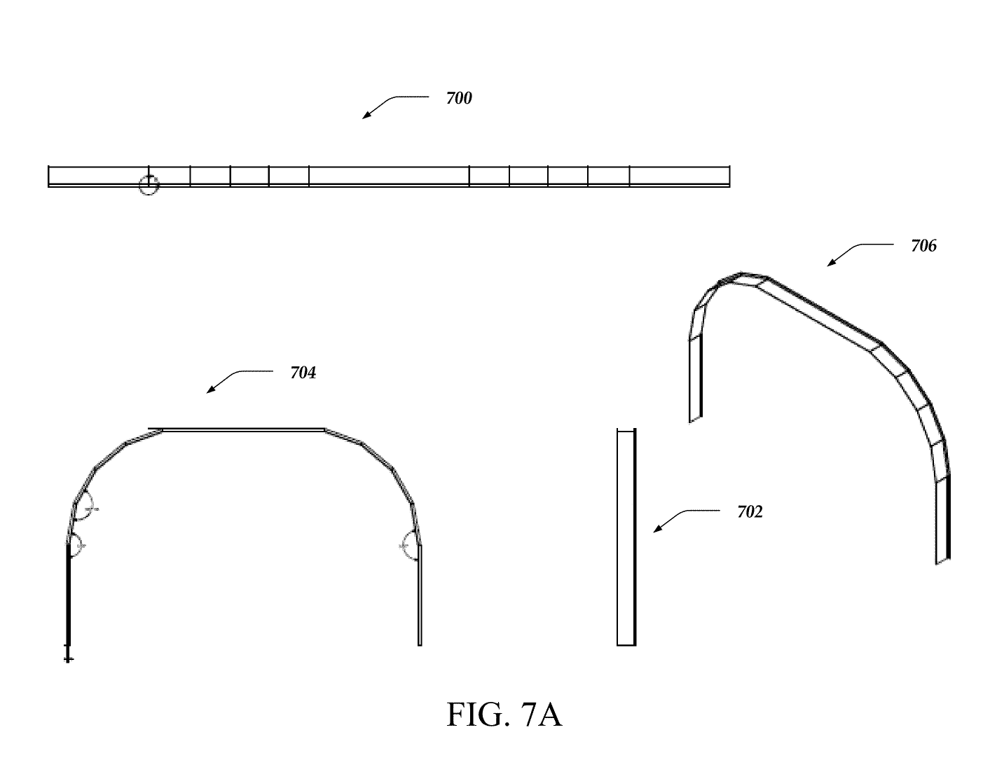

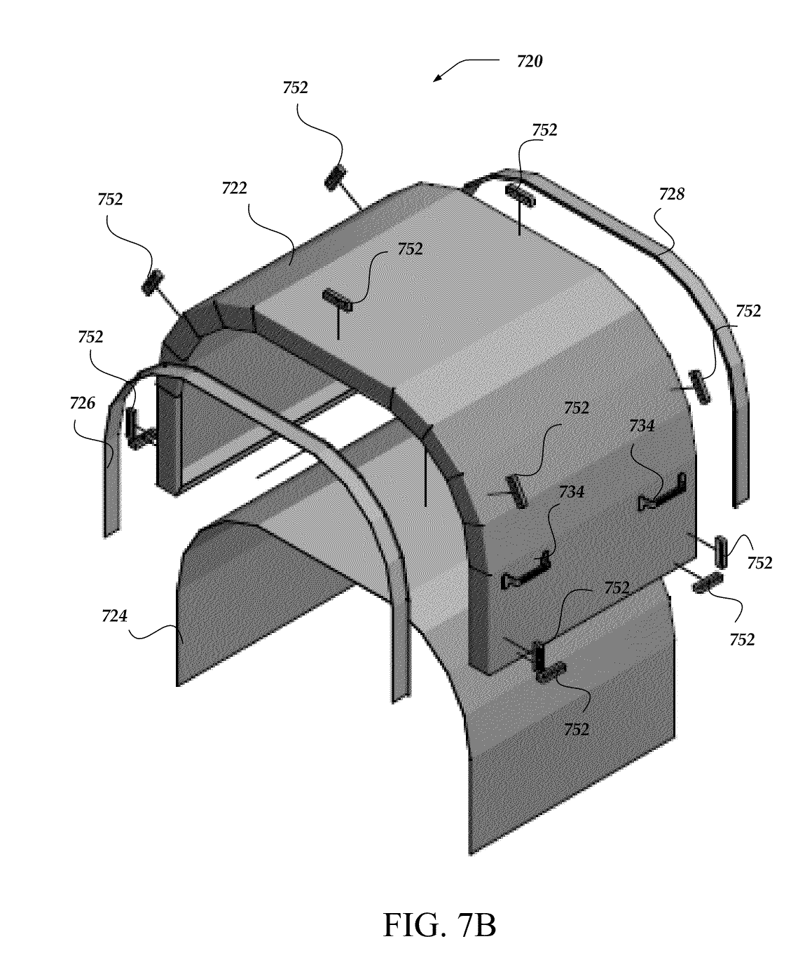

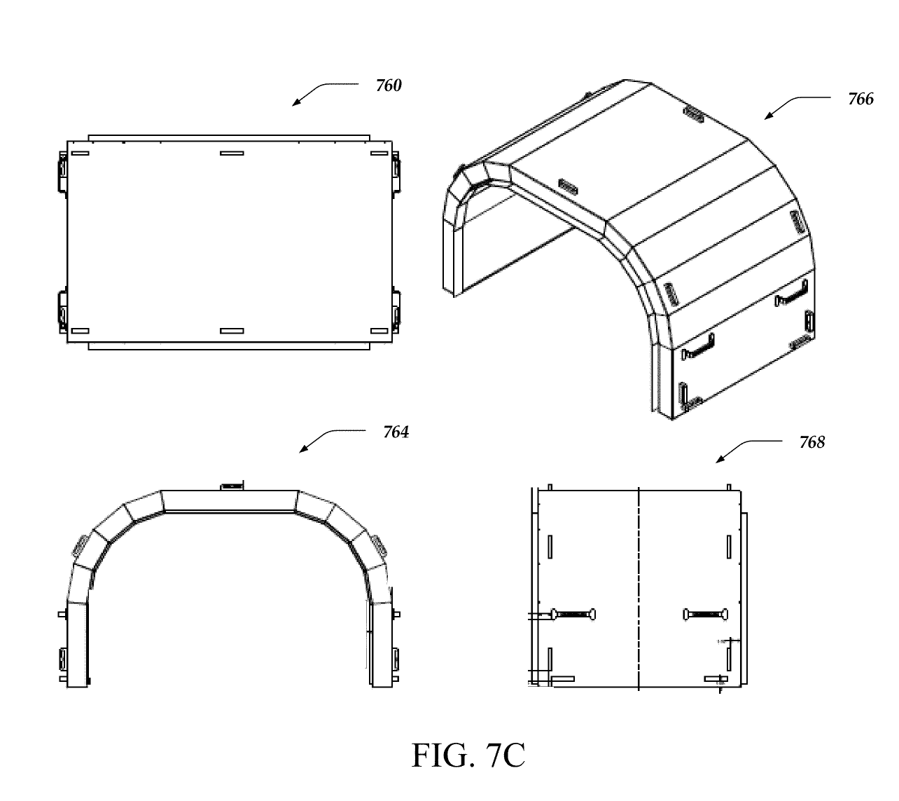

FIG. 7A illustrates various views of an inner shiplap that is consistent with the various embodiments disclosed herein. View 700 of FIG. 7A shows a single sheet of stainless steel that has been cut and scored to form an inner shiplap of a top-cover or an end-cap segment. View 702 shows a side-view of the inner shiplap constructed from sheet of view 700. View 704 shows a front-view of the inner shiplap. View 706 shows an off-axis view of the inner shiplap.

FIG. 7B illustrates an exploded view of a top-cover segment that includes two inner shiplaps, one on each longitudinal end of the top-cover segment that is consistent with the various embodiments. Top-cover segment 720 includes inner sheet 724, outer sheet 722, first inner shiplap 276, and second inner shiplap 728. Top-cover segment 720 also includes a plurality of brackets 752 and handles 734.

FIG. 7C shows various views of the completed top-cover segment that includes inner shiplaps on both longitudinal ends of the top-cover segment. View 760 shows a top-view of the top-cover segment that includes two inner shiplaps. View 764 shows a front-view of the top-cover segment. View 766 shows an off-axis view of the top-cover segment. View 768 shows an side-view of the top-cover segment.

In some embodiments, every other top-cover segment includes inner shiplaps of both longitudinal ends. When the insulating assembly is installed around the exhaust manifolds, top-cover segments without the inner shiplaps are sandwiched between top-cover segments with the inner shiplaps on each of the longitudinal ends. According, each seam or interface between top cover segments is sealed on the inner surface of the assembly by an inner shiplap. As shown above, outer shiplaps also cover the outer portions of the seams between the top-cover segments to provide a greater thermal seal of the seams. Additionally, a thermal tape or thermal film may be interposed between the sidewalls of the adjacent top-cover segments to provide an even greater thermal seal. In preferred embodiments, the positioning of the thermal tape is stabilized with tabs that crimp the tape and hold the tape in place. In some embodiments, glue is used to at least temporarily couple to thermal tape to the various surfaces.

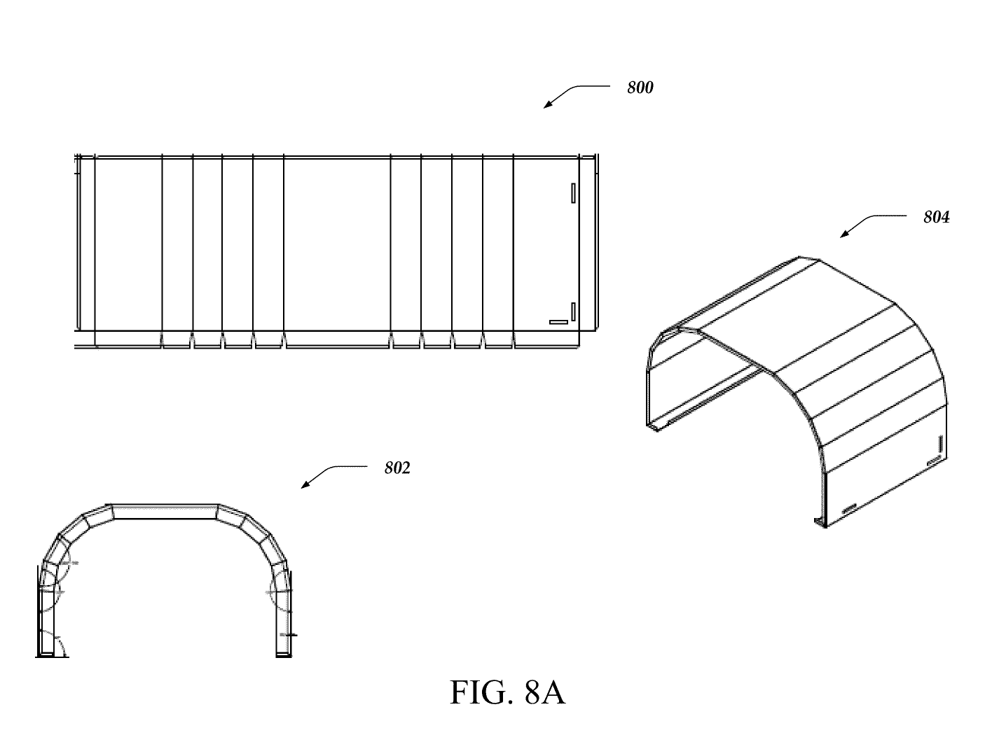

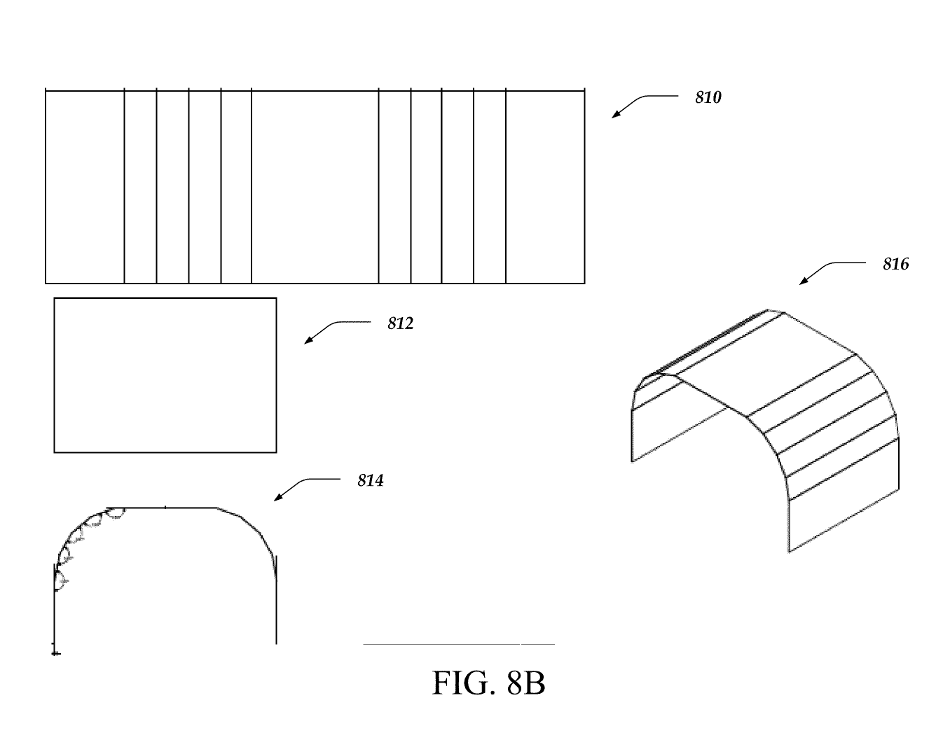

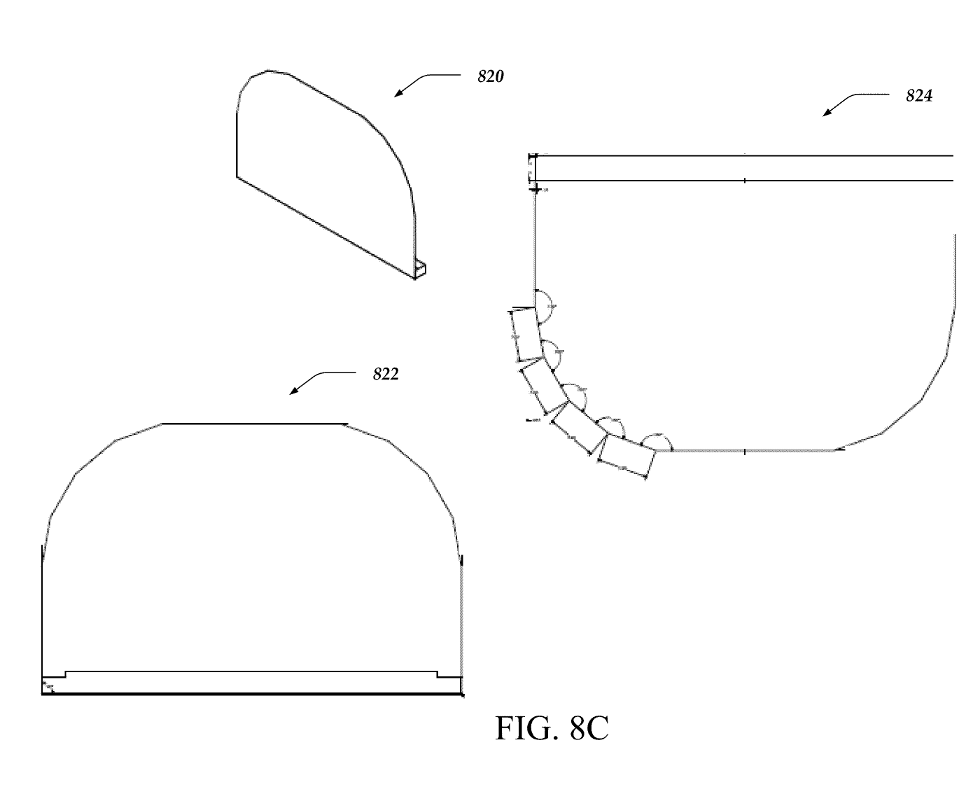

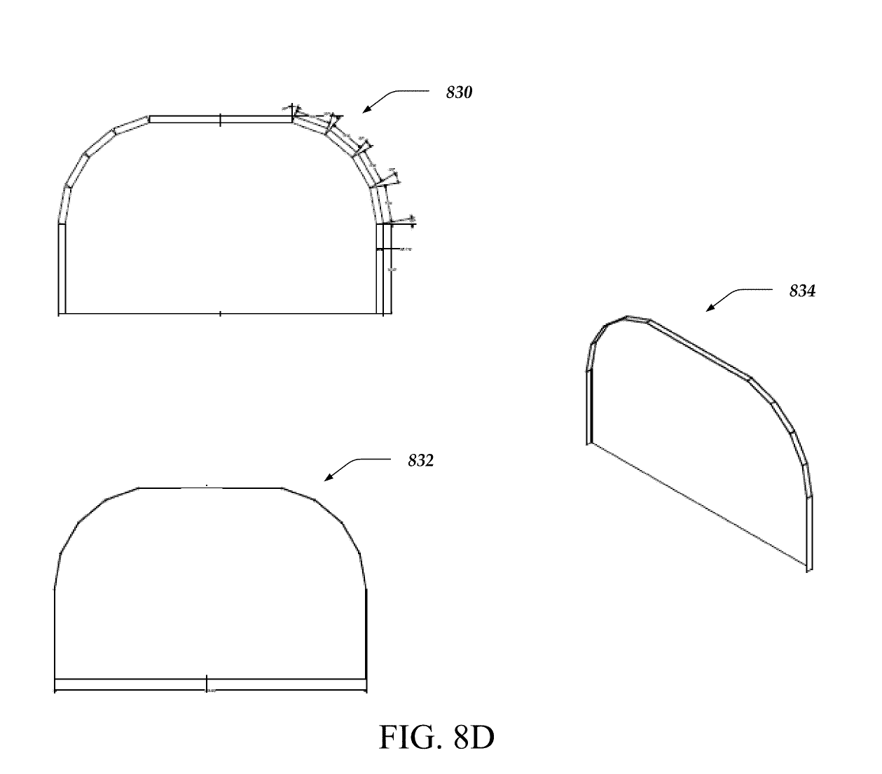

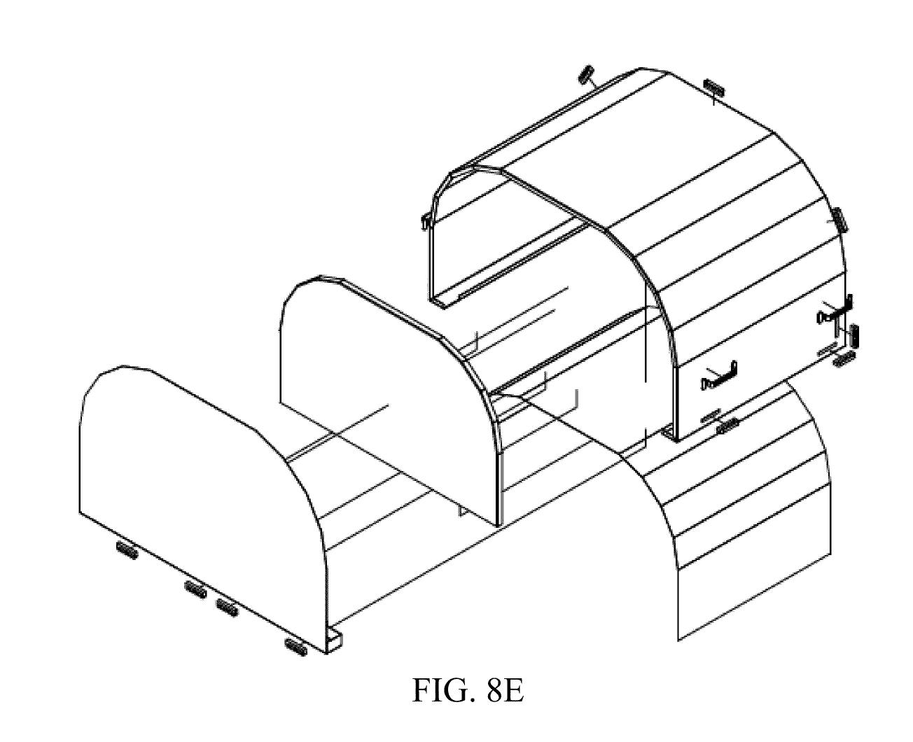

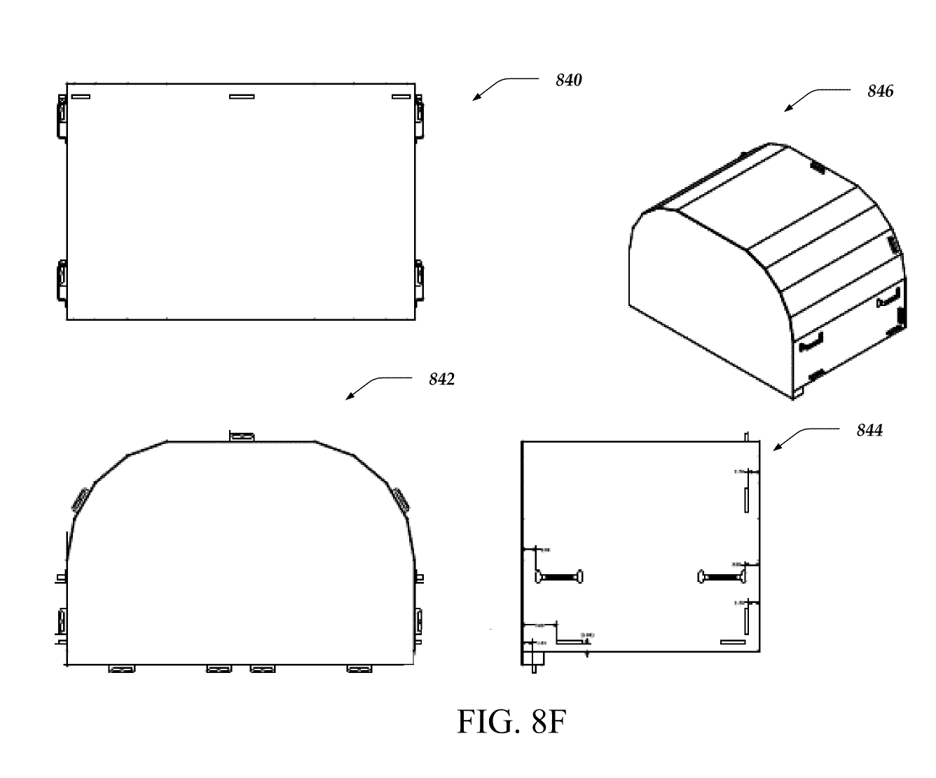

The construction of an end-cap segment is similar to that of the top-cover segment, except one of the longitudinal ends is capped with an inner and an outer-end-cap wall. FIG. 8A illustrates various views of an outer sheet for an end-cap segment that is consistent with the various embodiments disclosed herein. View 800 of FIG. 8A shows a single sheet of stainless steel that has been cut and scored to form an outer sheet of an end-cap segment. View 802 shows a front-view of the outer sheet. View 804 shows an off-axis view of the outer sheet.

FIG. 8B illustrates various views of an inner sheet for an end-cap segment that is consistent with the various embodiments disclosed herein. View 810 of FIG. 8B shows a single sheet of stainless steel that has been cut and scored to form an inner sheet of an end-cap segment. View 812 shows a top-view of the inner sheet. View 814 shows a front-view of the inner sheet. View 816 shows an off-axis view of the inner sheet.

FIG. 8C shows various views of an outer end-cap wall of an end-cap segment that is consistent with the various embodiments disclosed herein. View 824 of FIG. 8C shows a single sheet of stainless steel that has been cut and scored to form the outer end-cap wall of an end-cap segment. View 820 shows an off-axis view of the outer end-cap wall. View 822 shows a front-view of the outer end-cap wall.

FIG. 8D shows various views of an inner end-cap wall of an end-cap segment that is consistent with the various embodiments disclosed herein. View 830 of FIG. 8D shows a single sheet of stainless steel that has been cut and scored to form the inner end-cap wall of an end-cap segment. View 834 shows an off-axis view of the inner end-cap wall. View 832 shows a front-view of the inner end-cap wall.

FIG. 8E illustrates an exploded view of an end-cap segment that is consistent with the various embodiments disclosed herein. FIG. 8F shows various views of the completed end-cap segment of FIG. 8E. View 840 of FIG. 8F shows a top-view of the end-cap segment of FIG. 8E. View 846 shows an off-axis view of the end-cap segment. View 842 shows a front-view of the end-cap segment. View 844 shows a side-view of the end-cap segment.

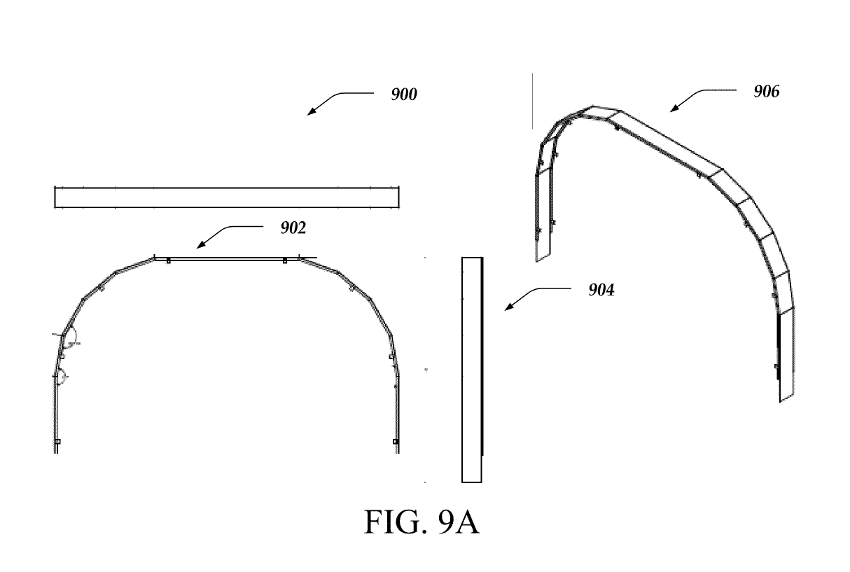

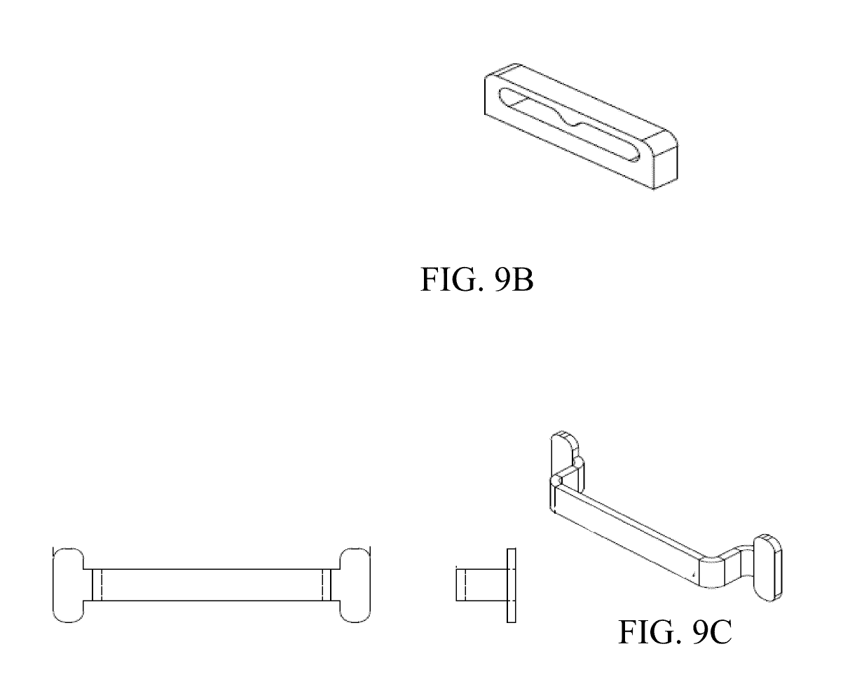

FIG. 9A shows various views of an outer shiplap that is employed to overlap adjacent top-cover and/or end-cap segments. As noted above, outer shiplaps are used to provide an outer heat seal for the seams between adjacent top-cover segments and/or end-cap segments. View 900 shows a top-view of an outer shiplap. View 902 shows a front-view of an outer shiplap. View 904 shows a side view of an outer shiplap. View 906 shows an off-axis view of an outer shiplap.

FIG. 9B shows a bracket that is included in various top-cover segments, end-cover segments, and lower-base segments as disclosed herein. As noted above, the brackets are welded onto various components of the insulating assembly. Through-bolts are used to couple to various components to form the modular assembly. FIG. 9C shows an embodiment of a handle that is welded onto various embodiments of top-cover segments, end-cap segments, and lower-base segments disclosed herein. The handle enables installers to manipulate and move the various components.

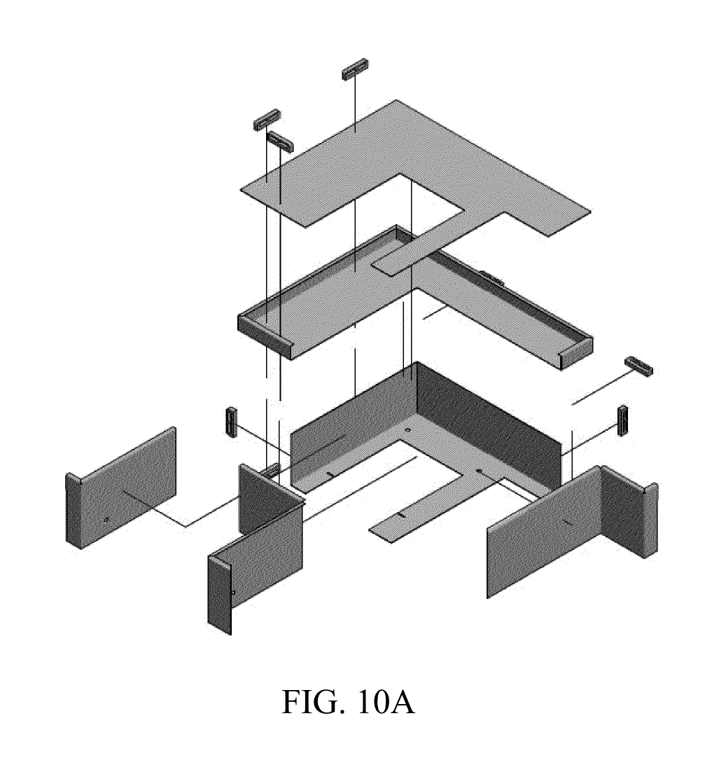

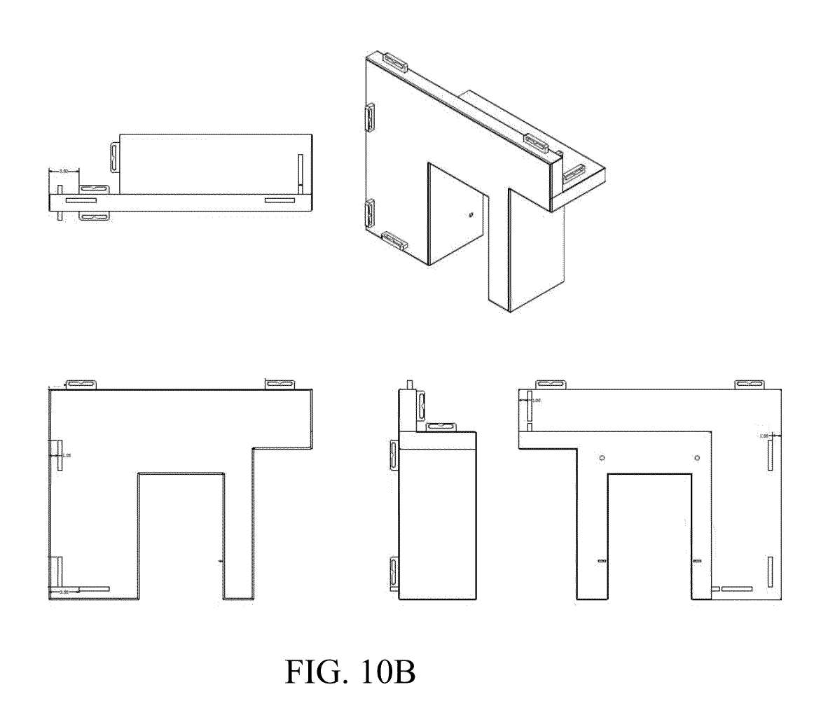

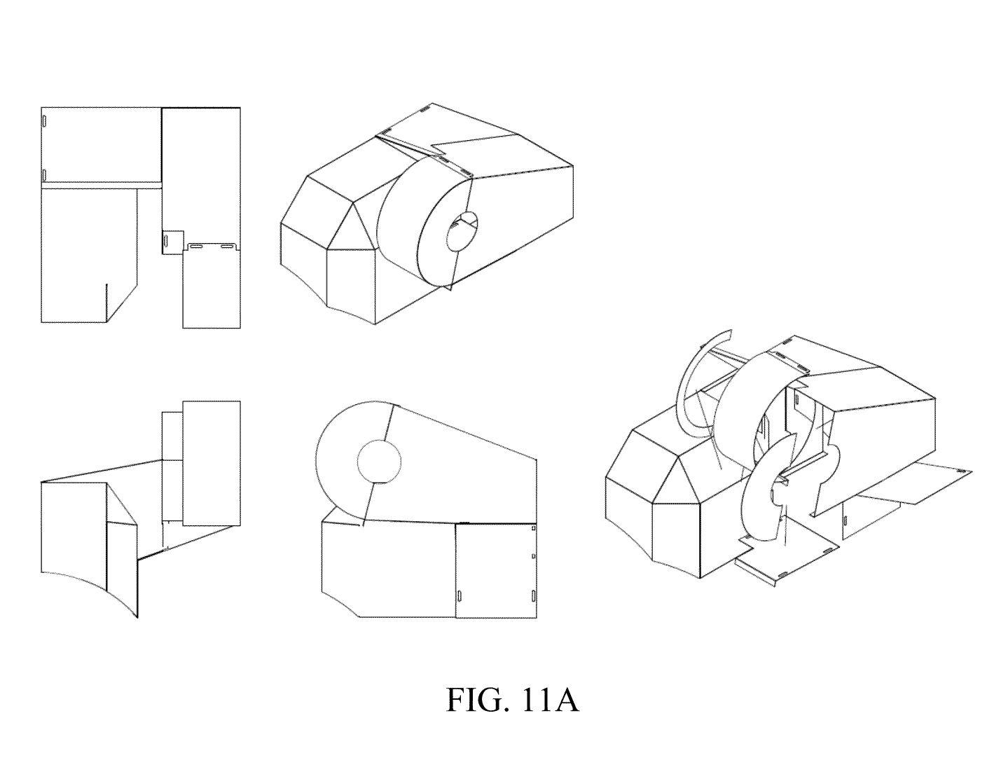

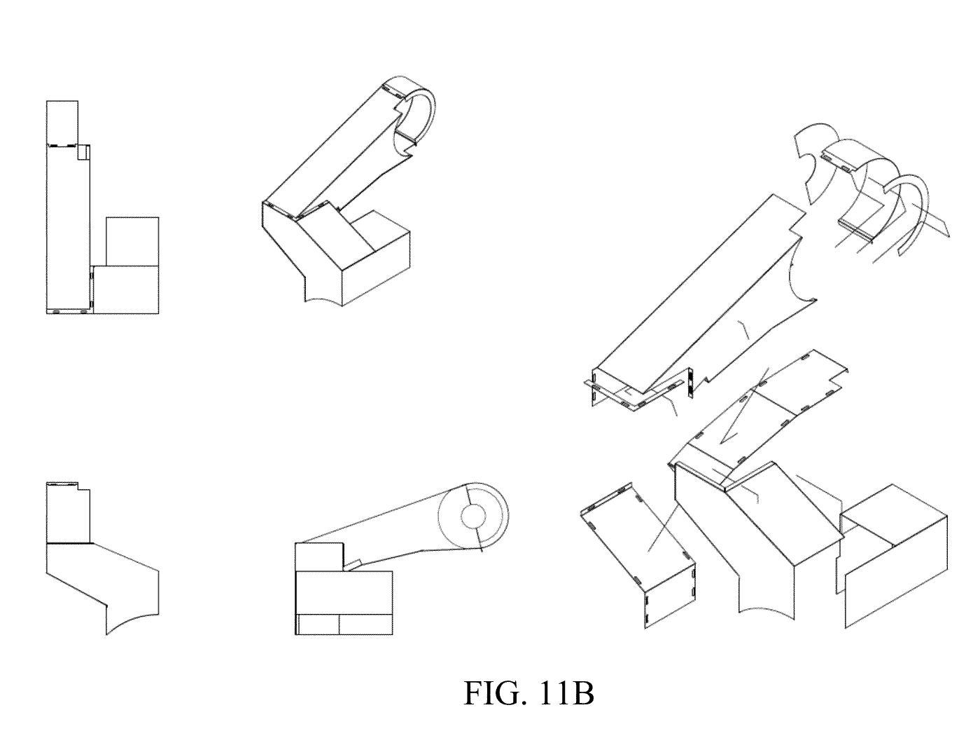

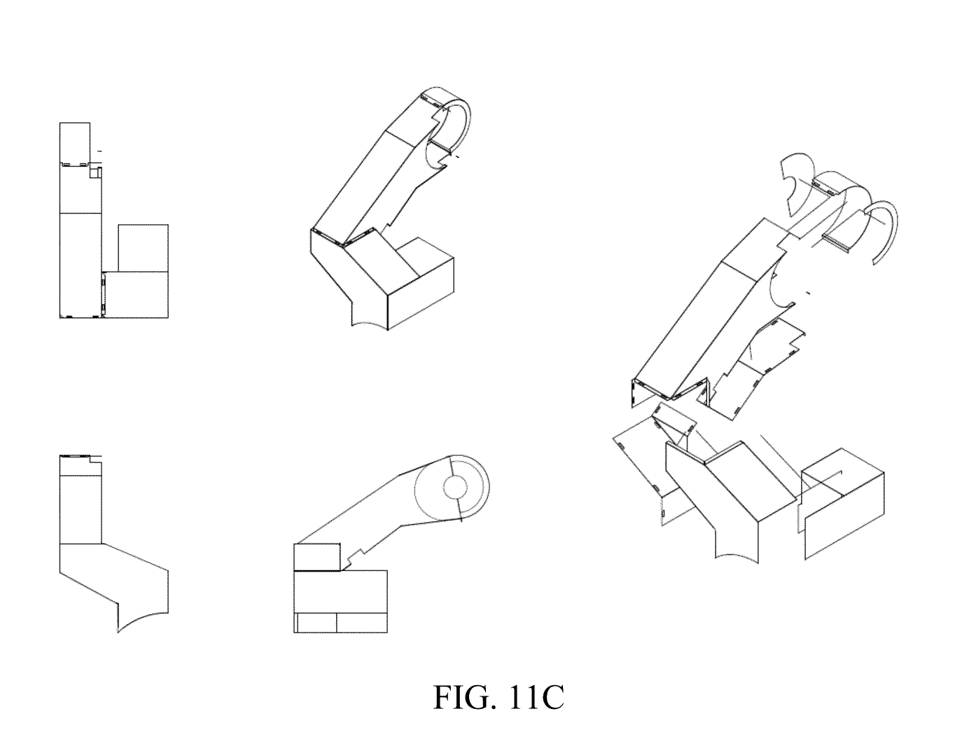

FIG. 10A shows an exploded view of a lower-base segment that is consistent with the various embodiments disclosed herein. FIG. 10B shows various views of an assembled lower-base segment that is consistent with the embodiments disclosed herein. FIG. 11A shows various views of a V-12 wastegate segment for a V-12 engine configuration. FIG. 11B shows various views of a V-16 wastegate segment for a V-12 engine. FIG. 11C shows various views of a V-16 wastegate segment for a V-16 engine configuration.

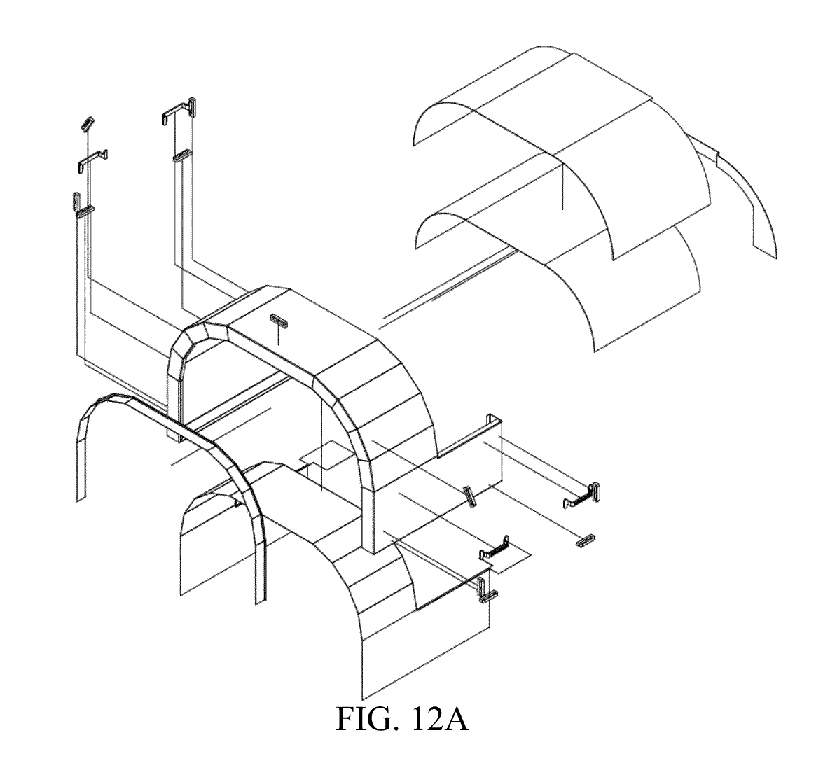

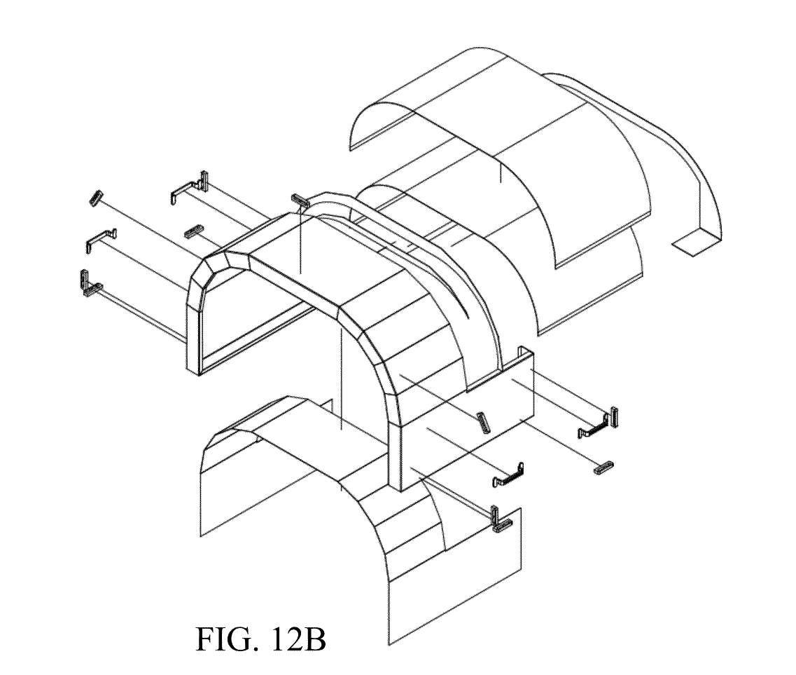

FIG. 12A shows an exploded view for a turbo end-cover segment for a V-12 engine configuration. FIG. 12 B shows an exploded view for a turbo upper fitment for a V-16 engine configuration. Various other components, such as spray-skirts, flanges, mounting rails, brackets, and other shiplaps, may be used to provide additional support, construction, or further insulation capabilities.

All of the embodiments and methods disclosed and claimed herein can be made and executed without undue experimentation in light of the present disclosure. While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A modular thermal-insulating assembly for thermally insulating an exhaust duct of an engine, the assembly comprising:
a lower-base segment that is positioned vertically below the exhaust duct; and
a top-cover segment that includes a top-cover outer wall that has a first lateral portion, a second lateral portion, and a horizontal portion, wherein the top-cover segment is coupled to a portion of the lower-base segment such that a portion of the exhaust duct is vertically intermediate the portion of the lower-base segment and the horizontal portion of the top-cover outer wall and laterally intermediate the first and the second lateral portions of the top-cover outer wall.

2. The assembly of claim 1, wherein the top-cover segment includes a first longitudinal opening and a second longitudinal opening that opposes the first longitudinal opening such that the portion of the exhaust duct is longitudinally intermediate the first and the second longitudinal openings, and a first end of the exhaust duct longitudinally extends out the first longitudinal opening and a second end of the exhaust duct longitudinally extends out of the second longitudinal opening of the top-cover segment.

3. The assembly of claim 2 further comprising:
an end-cap segment that includes a longitudinal opening and an end-cap outer wall that has a first lateral portion, a second lateral portion, a horizontal portion, and a longitudinal portion that opposes the end-cap longitudinal opening, wherein
the end-cap segment is positioned longitudinally adjacent the top-cover segment and the end-cap segment is coupled to another portion of the lower-base segment such that the second end of the exhaust duct is vertically intermediate the other portion of the lower-base segment and the horizontal portion of the end-cap outer wall, laterally intermediate the first and the second lateral portions of the end-cap outer wall, and longitudinally intermediate the longitudinal opening of the end-cap segment and the longitudinal portion of the end-cap outer wall.

4. The assembly of claim 3 further comprising:
a shiplap that is positioned longitudinally intermediate the top-cover segment and the end-cap segment, wherein a portion of the shiplap overlaps the top-cover outer wall and another portion of the shiplap overlaps the end-cap outer wall such that an interface between the longitudinally adjacent top-cover segment and the end-cap segment is completely covered by the shiplap.

5. The assembly of claim 4, wherein the shiplap is an outer shiplap such that the top-cover outer wall and the end-cap outer wall are intermediate the outer shiplap and the exhaust duct.

6. The assembly of claim 4, wherein the shiplap is an inner shiplap that is intermediate the exhaust duct and the top-cover outer wall and the end-cap outer wall.

7. The assembly of claim 1, wherein the top-cover segment includes a top-cover outer wall and a volume between the top-cover outer wall and the top-cover inner wall includes a thermally insulating material.

8. The assembly of claim 1 further comprising:
a wastegate segment that is positioned over a wastegate of the engine to thermally insulate the wastegate.

9. A module that is configured and arranged to thermally insulate an exhaust duct of an engine for a watercraft, the module comprising:
an inner wall that includes a first inner lateral portion, a second inner lateral portion, and an inner upper portion;
an outer wall that includes a first outer lateral portion that opposes the first inner later portion, a second outer lateral portion that opposes the second inner lateral portion, and an outer upper portion that opposes the inner upper portion; and
an insulating material that is disposed intermediate the inner wall and the outer wall.

10. The module of claim 9, wherein the module is enabled to hold a weight of at least 200 pounds placed upon the outer upper portion.

11. The module of claim 9, wherein the insulating material is fiberglass.

12. The module of claim 9, wherein the inner wall is constructed from a first sheet of stainless steel and the outer wall is constructed from a second sheet of stainless steel.

13. The module of claim 9, wherein the module is an end-cap module and further comprises an end cap that includes:
an inner end-cap wall;
an outer end-cap wall that opposes the inner end-cap wall, wherein the inner and the outer end-cap walls are disposed at a first longitudinal end of the module; and
additional insulating material that is disposed intermediate the inner and outer end-cap walls.

14. The module of claim 9, further comprising:
a first longitudinal flange positioned on a first longitudinal perimeter of the outer wall and is coupled to a first longitudinal perimeter of the inner wall; and
a second longitudinal flange positioned on a second longitudinal perimeter of the outer wall and is coupled to a second longitudinal perimeter of the inner wall, wherein the first and the second longitudinal flanges couple the inner and the outer walls.

15. The module of claim 9, further comprising:
a lower-base segment that is positioned underneath both the inner and the outer walls, wherein the lower-base segment includes a lower-base wall that opposes both the inner upper portion of the inner wall and the outer upper portion of the outer wall.

16. The module of claim 9, wherein the outer wall includes a plurality of brackets that are operative to couple the module to other modules.

17. The module of claim 9, further comprising:
a shiplap that includes a first shiplap lateral portion, a second shiplap lateral portion, and a shiplap upper portion, wherein the first shiplap lateral portion is adjacent to a longitudinal perimeter of the first inner lateral portion of the inner wall, the second shiplap lateral portion is adjacent to a longitudinal perimeter of the second inner lateral portion of the inner wall, and the shiplap upper portion is adjacent to a longitudinal perimeter of the inner upper portion of the inner wall.

18. A modular system for thermally insulating an exhaust duct of an engine, the system comprising:
a plurality of top-cover segments aligned along a longitudinal axis;
an end-cap segment that is positioned adjacent to a distal top-cover segment of the plurality of top-cover segments and aligned on the longitudinal axis; and
a plurality of lower-base segments, wherein each of the plurality of lower-base segments is below one or more of the plurality top-cover segments or the end-cap segment,
wherein the exhaust duct is received by each of the plurality of top-cover segments and the end-cap segment, such that plurality of top-cover segments, the end-cap segment, and the plurality of lower-base segments house the exhaust duct.

19. The system of claim 18, further comprising:
a plurality of wastegate segments to house a plurality of wastegates of the engine.

20. The system of claim 18, wherein the plurality of top-cover segments include at least five top-cover segments.
